(19) United States
(12) Patent Application Publication
(10) Pub. No.: US 2006/0105213 A1
(43) Pub. Date: May 18, 2006

(54) Separator, fuel cell device, and temperature control method for fuel cell device

(76) Inventor: Kazuhiko Otsuka, Tokyo (JP)

Correspondence Address: BELL, BOYD & LLOYD, LLC, P. O. BOX 1135, CHICAGO, IL, 60690-1135, US

(21) Appl. No.: 10/541,690

(22) PCT Filed: Mar. 5, 2004
(86) PCT No.: PCT/JP04/02891

§ 371 Date: Jul. 7, 2005

(30) Foreign Application Priority Data
Mar. 5, 2003 (JP) 2003058399
Mar. 12, 2003 (JP) 2003066996

(51) Int. Cl. H01M 8/04; H01M 8/24

(52) U.S. Cl. 429/26; 429/34; 165/904

(57) ABSTRACT

Separator, fuel cell device and temperature control method for fuel cell device are provided. The sectional areas S₁ to S₄ of thermal radiation fins are determined by the magnitude of the widths w₁ to w₄, since the thermal radiation fins have the same thickness t. The thermal radiation fins are provided in the condition where the widths w₁ to w₄ of the thermal radiation fins are so regulated that the sectional area S₁ of the thermal radiation fin is the smallest and that the sectional areas S₂, S₃ and S₄ are reduced in this order. In other words, the quantities of heat radiated are regulated according to the sectional areas S₁ to S₄ of the thermal radiation fins and it is possible to reduce the temperature gradient in a power generation unit with respect to the lamination direction, and to keep substantially uniform the temperature of the power generation unit. This makes it possible, in a power generation unit having a stack structure, to suppress dispersions in the temperature of the power generation unit along the lamination direction of power generation bodies and separators, and to keep uniform the temperature of the power generation unit.

### CROSS REFERENCE TO RELATED APPLICATION

The present application claims priority to Japanese Patent Document Nos. P2003-058399 filed on Mar. 5, 2003, and P2003-066996 filed on Mar. 12, 2003, the disclosures of which are herein incorporated by reference.

### BACKGROUND OF THE INVENTION

The present invention relates to a separator, a fuel cell device, and a temperature control method for a fuel cell device by which it is possible to maintain at a substantially uniform value the temperature of a fuel cell device during power generation.

A fuel cell is a power generation device for generating electric power by bringing a fuel gas such as, for example, hydrogen gas and an oxidant gas such as oxygen gas into an electrochemical reaction. Since the reaction product produced through power generation in the fuel cell is water, the fuel cell has been paid attention to in recent years as a power generation device which does not cause environmental pollution.

Besides, the fuel cell makes it possible to enhance the quantity of electric power outputted, by connecting a plurality of power generation cells. For example, a joint body including electrodes on both sides of a solid polymer electrolyte membrane is used as a power generation body, which is sandwiched between separators to form a power generation cell. Further, a fuel cell in which a fuel cell main body having a stack structure of such power generation cells laminated on each other constitutes a power generation unit has been developed.

Since the fuel cell generates electric power by the chemical reaction between hydrogen and oxygen, heat is generated due to the loss component arising from the electrochemical reaction, the electric resistances of the materials constituting the power generation unit and the like, leading to a rise in the temperature of the fuel cell main body in which the power generation cells are laminated. The fuel cell main body is the power generation unit which substantially performs power generation, and the temperature rise in the power generation unit is unfavorable for the purpose of stable power generation. For example, in a solid polymer type fuel cell having a power generation body composed of a solid polymer electrolyte membrane and electrodes sandwiching the solid polymer electrolyte membrane therebetween, the amount of moisture contained in the solid polymer electrolyte membrane may in some cases be reduced attendant on the temperature rise, resulting in the trouble called “dry-up”. Therefore, for achieving stable power generation in the condition where a preferable quantity of moisture is contained in the solid polymer electrolyte membrane, the technology of releasing the heat from the power generation unit as the fuel cell main body to the exterior is important.

Development of a variety of technologies has been vigorously carried out in order to improve these problems. As a technology for releasing heat from the power generation unit having the stack structure, there has been known a technology in which each of the separators disposed in the power generation unit having the stack structure is provided with a thermal radiation fin or fins (refer to, for example, Japanese Patent Laid-open No. Hei 10-162842. In addition, a technology in which the power generation unit is cooled by a plate type heat pipe has also been proposed (refer to, for example, Japanese Patent Laid-open No. Hei 11-214017 and Japanese Patent Laid-open No. 2000-353536).

According to the technology disclosed in Japanese Patent Laid-open No. Hei 10-162842, however, in the power generation cell composed of a power generation body and separator main body portions sandwiching the power generation body therebetween by making direct contact with the power generation body, the heat generated during power generation is not only released to the exterior through the thermal radiation fins provided in the separator main body portions but also released through other side edge portions of the separator main body portions. Further, the heat generated in the power generation cell is not only transferred from the separator main body portions to the thermal radiation fins but also transferred in the height direction of the power generation unit, i.e., in the lamination direction in which the separator main body portions and the power generation bodies are laminated. Therefore, in the power generation unit having the stack structure, when comparison in temperature is applied to an upper portion, a central portion and a lower portion of the power generation unit at the time of power generation, the temperature at each portion may differ according to the position at which the portion is disposed with respect to the above-mentioned lamination direction. Specifically, there is a tendency that the temperature of a power generation cell located at a central portion of the power generation unit with respect to the lamination direction would be higher than the temperatures of the other power generation cells, and the temperatures of the power generation cells constituting the upper portion and lower portion of the power generation unit would be lower. When power generation is conducted in the condition where temperature gradients are generation over the range from the central portion to the upper portion of the power generation unit and over the range from the central portion to the lower portion of the power generation unit, such troubles as the dry-up may be generated in the power generation cell higher in temperature than the other power generation cells, particularly in the power generation cell disposed in the vicinity of the center of the power generation unit, making it difficult to achieve stable power generation by the power generation unit.

Besides, also in the technology disclosed in Japanese Patent Laid-open No. Hei 11-214017 and Japanese Patent Laid-open No. 2000-353536, like in the technology described in Japanese Patent Laid-open No. Hei 10-162842, the technology of controlling the temperature of the power generation cells according to the positions of the power generation cells disposed in the power generation unit is not referred to, and it is difficult, in the case of the power generation unit having the stack structure, to improve the temperature gradients generated with respect to the lamination direction of the power generation bodies and the separator main body portions, and to perform power generation while keeping uniform the temperature of the power generation unit as a whole.

Further, in order to efficiently release heat from the thermal radiation fins, it is important to provide environmental conditions suitable for easy transfer of heat between the thermal radiation fins and air which is present in the surroundings of the thermal radiation fins and which cools the thermal radiation fins. Furthermore, the quantity of heat radiated from the thermal radiation fins varies according to the size and shape of the thermal radiation fins, and, particularly for reducing the size of the power generation unit, it is important to design the size and shape of the thermal radiation fins in such a manner as to promise efficient radiation of heat. In Japanese Patent Laid-open No. Hei 10-162842, however, it is described only that the thermal radiation fins for releasing heat from the power generation unit are formed of a metallic material such as aluminum and are flat plate-like in shape, and the detailed shape of the thermal radiation fins for enabling a further enhancement of thermal radiation efficiency is not referred to.

According to the technology disclosed in Japanese Patent Laid-open No. Hei 11-214017 and Japanese Patent Laid-open No. 2000-353536, a heat pipe is used as a heat transfer member for releasing heat from the power generation unit to the exterior. In the case of the fuel cell having a separator with such a heat pipe connected thereto, the structure of the fuel cell is necessarily complicated, which may cause a hindrance in reducing the size of the fuel cell. Therefore, there is a need for a technology which makes it possible to efficiently release heat from a fuel cell, to achieve stable power generation, and to sufficiently cope with a reduction in the size of the fuel cell.

### SUMMARY

Accordingly, in consideration of the above-mentioned problems, the present invention to provides in an embodiment a separator, a fuel cell device, and a temperature control method for a fuel cell device by which it is possible to control the temperature of each power generation cell according to the position where the power generation cell is disposed with respect to the lamination direction in a power generation unit having a stack structure, and to perform power generation while keeping substantially uniform the temperature of the power generation unit as a whole.

Besides, in consideration of the above-mentioned problems, it is another object of the present invention provides in another embodiment a separator, a fuel cell device, and a temperature control method for a fuel cell device by which it is possible to enhance the efficiency of release of heat from a power generation unit and to reduce the size of a fuel cell.

According to the present invention in an embodiment, there is provided a separator laminated so as to make electrical conduction between a power generation body and another power generation body, including: a separator main body portion making contact with the power generation bodies; and a thermal radiation portion projectingly provided at a side edge portion of the separator main body portion; wherein the sectional area of the thermal radiation portion is set to differ according to the difference in the position at which the separator main body portion is disposed with respect to the lamination direction of the power generation bodies and the separator main body portion. According to the separator of the present invention in an embodiment, the quantity of heat transferred from each separator main body portion to the thermal radiation portion differs depending on the magnitude of the sectional area of the thermal radiation portion, and it is therefore possible to transfer a predetermined quantity of heat from each separator main body portion to each thermal radiation portion so that the temperature of the power generation unit as a whole will be uniform.

In the separator according to the present invention in an embodiment, in the fuel cell main body having the power generation units and the separator main body portions laminated on each other, the sectional area of the thermal radiation portion may be greater than the sectional area of a thermal radiation portion disposed on the outer side of the first-mentioned thermal radiation portion with respect to the lamination direction. According to such a thermal radiation portion as this, the quantity of heat transferred from the power generation cell, composed of the power generation body and the separator main body portions, to the thermal radiation portion can be controlled according to the position at which the power generation cell is disposed, and the temperature of each power generation cell can be made substantially uniform with respect to the lamination direction of the power generation bodies and the separator main body portions.

In the separator according to the present invention in an embodiment, the thermal radiation portion may be substantially flat plate-like. According to such as thermal radiation portion, by changing a predetermined size of the thermal radiation portion at the time of setting the sectional area of the thermal radiation portion, it is possible to accurately set the sectional area.

In the separator according to the present invention in an embodiment, the sectional area of the thermal radiation portion may be set by varying at least one of the width and the thickness of the thermal radiation portion. According to such a separator, it is possible not only to make uniform the temperature of the power generation unit as a whole by varying at least one of the width and the thickness of the thermal radiation portion, but also to easily design the thermal radiation portion so that the temperature of the power generation unit as a whole will be substantially uniform.

According to the present invention in an embodiment, there is provided a separator laminated so as to make electrical conduction between a power generation body and another power generation body, including: a separator main body portion making contact with the power generation bodies; and a thermal radiation portion projectingly provided at a side edge portion of the separator main body portion; wherein the surface area of the thermal radiation portion is set to differ according to the difference in the position at which the separator main body portion is disposed with respect to the lamination direction of the power generation bodies and the separator main body portion. According to the separator of the present invention in an embodiment, the temperature of the power generation unit can be made substantially uniform by controlling the quantity of heat radiated from each thermal radiation portion according to the magnitude of the surface area of the thermal radiation portion and radiating a predetermined quantity of heat from each thermal radiation portion so that the temperature of the power generation unit as a whole will be uniform.

In the separator according to the present invention in an embodiment, the surface area of the thermal radiation portion may be greater than the surface area of a thermal radiation portion disposed on the outer side relative to the first-mentioned thermal radiation portion in the lamination direction in the fuel cell main body having the power generation bodies and the separator main body portions laminated on each other. According to such a thermal radiation portion, it is possible to control the quantity of heat radiated from the thermal radiation portion according to the position at which the power generation cell composed of the power generation body and the separator main body portions is disposed, and to make substantially uniform the temperature of each power generation cell with respect to the lamination direction of the power generation bodies and the separator main body portions.

In the separator according to the present invention in an embodiment, the thermal radiation portion may be substantially flat plate-like. According to such a thermal radiation portion, the surface area of the thermal radiation portion can be accurately set by varying a predetermined size of the thermal radiation portion at the time of setting the surface area.

In the separator according to the present invention in an embodiment, the surface area of the thermal radiation portion may be set by varying at least one of the width, the length, and the thickness of the thermal radiation portion. According to such a separator, it is possible not only to make uniform the temperature of the power generation unit as a whole, but also to easily design the thermal radiation portion so as to make substantially uniform the temperature of the power generation unit as a whole by varying at least one of the width, the length, and the thickness of the thermal radiation portion.

According to the present invention in an embodiment, there is provided a separator laminated so as to make electrical conduction between a power generation body and another power generation body, including: a separator main body portion making contact with the power generation bodies; and a thermal radiation portion projectingly provided at a side edge portion of the separator main body portion; wherein the thermal emissivity of the thermal radiation portion is set to differ according to the difference in the position at which the separator main body portion is disposed with respect to the lamination direction of the power generation bodies and the separator main body portion. According to the separator of the present invention in an embodiment, it is possible to control the quantity of heat radiated from each thermal radiation portion according to the magnitude of the thermal emissivity of the thermal radiation portion, and to make substantially uniform the temperature of the power generation unit as a whole.

In the separator according to the present invention in an embodiment, the thermal emissivity of the thermal radiation portion may be greater than the thermal emissivity of a thermal radiation portion disposed on the outer side relative to the first-mentioned thermal radiation portion with respect to the lamination direction in the fuel cell main body having the power generation bodies and the separator main body portions laminated on each other. According to such a thermal radiation portion, it is possible to control the quantity of heat radiated from each thermal radiation portion according to the position at which the power generation cell composed of the power generation body and the separator main body portions is disposed, and to make substantially uniform the temperature of each power generation cell with respect to the lamination direction of the power generation bodies and the separator main body portions.

In the separator according to the present invention in an embodiment, the thermal emissivity of the thermal radiation portion may be set by varying the surface roughness of a surface of the thermal radiation portion. According to such a separator, it is possible to vary the quantity of heat radiated from the thermal radiation portion, without modifying the design, such as size and outer shape, of the thermal radiation portion.

Further, in the separator according to the present invention in an embodiment, the thermal emissivity of the thermal radiation portion may be set by changing a surface treatment applied to the surface of the thermal radiation portion. According to such a separator, it is possible to vary the quantity of heat radiated from the thermal radiation portion, without modifying the design, such as size and outer shape, of the thermal radiation portion.

According to the present invention in an embodiment, there is provided a fuel cell device including a fuel cell main body having a separator laminated so as to make electrical conduction between a power generation body and another power generation body, wherein the separator includes a separator main body portion making contact with the power generation bodies, and a thermal radiation portion projectingly provided at a side edge portion of the separator main body portion; and the interval between the thermal radiation portions adjacent to each other with respect to the lamination direction of the power generation units and the separator main body portions is set to a required interval according to the difference in the position at which the thermal radiation portion is disposed in the fuel cell main body with respect to the lamination direction. According to the fuel cell device of the present invention in an embodiment, the flow rate of air flowing between the adjacent thermal radiation portions differs according to the position of the thermal radiation portion with respect to the lamination direction, whereby the quantity of heat radiated from the thermal radiation portion can be varied. This makes it possible to make uniform the temperature of the fuel cell main body as a whole, and to achieve stable power generation.

In the fuel cell device according to the present invention in an embodiment, thermal radiation from the thermal radiation portion is effected by causing an oxidizing fluid supplied to a fuel cell main body to flow between the thermal radiation portions. According to such a fuel cell device, the quantity of heat radiated from the thermal radiation portions can be varied by supplying an oxidizing fluid to the fuel cell main body and controlling the flow rate of the oxidizing fluid flowing between the adjacent thermal radiation portions. This makes it possible to make uniform the temperature of the fuel cell main body as a whole, and to achieve stable power generation.

Further, in the fuel cell device according to the present invention in an embodiment, the predetermined interval is smaller for the thermal radiation portions which are located on the outer side of the fuel cell main body with respect to the lamination direction and are adjacent to each other. According to such a fuel cell device, by suppressing the quantity of heat released from the power generation cell located on the outer side where temperature rise is smaller than at a central portion of the fuel cell main body, it is possible to suppress the rise in temperature of the fuel cell main body as a whole, and to make substantially uniform the temperature of the fuel cell main body.

In addition, in the fuel cell device according to the present invention in an embodiment, the thickness of the separator main body portion is smaller as the separator main body portion is located on the outer side of the fuel cell main body with respect to the lamination direction. According to such a fuel cell device, in the case where the thermal radiation portions having the same thickness are projectingly provided at each separator main body portion, the interval between the adjacent thermal radiation portions is determined according to the thicknesses of the separator main body portions disposed adjacent to each other, and the interval between a thermal radiation portion and the adjacent thermal radiation portion is smaller as the first-mentioned thermal radiation portion is located on the outer side of the fuel cell main body. This results in that the rise in temperature of the fuel cell main body is suppressed and, further, the quantity of heat radiated from a thermal radiation portion is suppressed more as the thermal radiation portion is located on the outer side of the fuel cell main body, whereby the temperature of the fuel cell main body as a whole can be made uniform.

Besides, in the fuel cell device according to the present invention in an embodiment, the difference between the thickness of the thermal radiation portion and the thickness of the separator main body portion at which the thermal radiation portion is projectingly provided may be smaller on the outer side of the fuel cell main body with respect to the lamination direction. According to such a fuel cell device, in connection with the separator main body portions disposed adjacent to each other, even in the case where the thicknesses of the individual separator main body portions and the thicknesses of the thermal radiation portions projectingly provided on the separator main body portions are both different, the interval between the adjacent thermal radiation portions is determined according to the difference between the thickness of the thermal radiation portion and the thickness of the separator main body portion on which the thermal radiation portion is projectingly provided, and the interval between a thermal radiation portion and the adjacent thermal radiation portion is smaller as the first-mentioned thermal radiation portion is located on the outer side of the fuel cell main body. This results in that the quantity of heat radiated from a thermal radiation portion is suppressed more as the thermal radiation portion is located on the outer side of the fuel cell main body, and the quantity of heat radiated from the thermal radiation portion is controlled according to the position at which the power generation cell is disposed, whereby the temperature of the fuel cell main body as a whole can be made uniform.

According to the present invention in an embodiment, there is provided a fuel cell device including a fuel cell main body having a separator laminated so as to make electrical conduction between a power generation body and another power generation body adjacent to the first-mentioned power generation body, wherein the separator includes a separator main body portion making contact with the power generation bodies, and a thermal radiation portion projectingly provided at a side edge portion of the separator main body; and the sectional area of the thermal radiation portion is set to differ according to the difference in the position at which the separator main body portion is disposed with respect to the lamination direction of the power generation bodies and the separator main body portion. According to such a fuel cell device, the quantity of heat transferred from each separator main body portion to the thermal radiation portion is controlled, and power generation can be performed in a stable condition while keeping uniform the temperature of the fuel cell main body as a whole.

According to the present invention in an embodiment, there is provided a fuel cell device including a fuel cell main body having a separator laminated so as to make electrical conduction between a power generation body and another power generation body, wherein the separator includes a separator main body portion making contact with the power generation bodies, and a thermal radiation portion projectingly provided at a side edge portion of the separator main body portion; and the surface area of the thermal radiation portion is set to differ according to the difference in the position at which the separator main body portion is disposed with respect to the lamination direction of the power generation bodies and the separator main body portion. According to such a fuel cell device, the quantity of heat radiated from the thermal radiation portions is controlled at each thermal radiation portion, and power generation can be performed in a stable condition while keeping uniform the temperature of the fuel cell main body as a whole.

According to the present invention in an embodiment, there is provided a fuel cell device including a fuel cell main body having a separator laminated so as to make electrical conduction between a power generation body and another power generation body, wherein the separator includes a separator main body portion making contact with the power generation bodies, and a thermal radiation portion projectingly provided at a side edge portion of the separator main body portion; and the thermal emmissivity of the thermal radiation portion is set to differ according to the difference in the position at which the separator main body portion is disposed with respect to the lamination direction of the power generation bodies and the separator main body portion. According to such a fuel cell device, the quantity of heat radiated from the thermal radiation portion can be controlled without changing the design, such as size and outer shape, of the thermal radiation portion, so that the temperature of the fuel cell main body as a whole can be easily kept substantially uniform without changing the design of the fuel cell main body.

According to the present invention in an embodiment, there is provided a temperature control method for a fuel cell device, for controlling the temperature of a fuel cell main body in which a power generation body and a separator for making electrical conduction between the power generation body and another power generation body are laminated, wherein the separator includes a separator main body portion making contact with the power generation bodies, and a thermal radiation portion projectingly provided at a side edge portion of the separator main body portion; a cooling fluid for cooling the fuel cell main body is made to flow in the circumference of the thermal radiation portion; and the quantity of heat radiated from the thermal radiation portion is controlled according to the difference in the position at which the thermal radiation portion is disposed with respect to the lamination direction of the thermal radiation portions and the separator. According to such a temperature control method for a fuel cell device, the quantity of heat radiated from the thermal radiation portions can be so controlled that the temperature of the fuel cell main body having a stack structure will be substantially uniform with respect to the lamination direction, and stable power generation can be achieved.

According to the present invention in an embodiment, there is provided a separator laminated so as to make electrical conduction between a power generation body and another power generation body, including: separator main body portion making contact with the power generation bodies; and a thermal radiation portion projectingly provided at a side edge portion of the separator main body portion; wherein the thickness of at least a part of an edge portion of the thermal radiation portion is smaller than the thickness of a central portion of the thermal radiation portion. According to the separator of the present invention, it is possible to reduce the resistance against the flow of a cooling fluid to which heat is transferred from the thermal radiation portion when the cooling fluid flows in the circumference of the thermal radiation portion, and it is ensured that the flow rate of the cooling fluid flowing between the thermal radiation portions is little reduced. Therefore, it is possible to secure a quantity of heat radiation according to the cooling fluid supplied externally at a fixed flow rate.

In the separator according to the present invention in an embodiment, the cooling fluid for cooling the thermal radiation portion may flow in the circumference of the thermal radiation portion. According to such a separator, it is possible to cause a fresh cooling fluid to flow in the circumference of the thermal radiation portion while discharging the cooling fluid having received heat from the thermal radiation portion, and heat can be released to the cooling fluid which always has a sufficient heat capacity at the time of performing power generation.

In such a separator, the edge portion of the thermal radiation portion may front on the side of an inlet through which the cooling fluid flows into the area between the thermal radiation portions located adjacent to each other in the lamination direction of the power generation bodies and the separator main body portion. According to such a separator, it is possible to cause the cooling fluid to flow smoothly between the adjacent thermal radiation portions. Therefore, the flow rate of the cooling fluid is not lowered even where the space between the adjacent thermal radiation portions is narrowed, so that the efficiency of thermal radiation from the thermal radiation portions is little lowered.

In addition, in such a separator, the edge portion of the thermal radiation portion may front on the side of an outlet through which the cooling fluid flows out of the area between the thermal radiation portions located adjacent to each other in the lamination direction of the power generation bodies and the separator main body portion. According to such a separator, it is possible to reduce the pressure loss generated on the outlet side of the area between the adjacent thermal radiation portions. Therefore, the flow rate of the cooling fluid is not lowered even where the space between the adjacent thermal radiation portions is narrowed, so that the thermal radiation efficiency is little lowered.

In the separator according to the present invention in an embodiment, the edge portion of the thermal radiation portion may extend along the direction in which the thermal radiation portion is projectingly provided and extends from the side edge portion of the separator main body portion. According to such a separator, the pressure loss at the time when the cooling fluid flows can be reduced at the whole part of the thermal radiation portions, and heat can be efficiently radiated from the whole part of the surfaces of the thermal radiation portions.

In the separator according to the present invention in an embodiment, the section of the edge portion may be tapered in shape. According to such a separator, the flow of the cooling fluid is little hindered by the edge portions of the thermal radiation portions, and the cooling fluid flows smoothly.

In such a separator, the section of a central portion may be rectangular in shape, and the edge portion may have an inclined surface inclined against the surface of the central portion. According to such a separator, the cooling fluid can flow smoothly at the time when the cooling fluid flows over the range from the edge portion to the central portion, and it is possible to suppress the interference between the cooling fluid flowing along the surfaces of the thermal radiation portions and the cooling fluid flowing between the adjacent thermal radiation portions. This ensures that the flow rate of the cooling fluid flowing between the adjacent thermal radiation portions is not lowered, and the thermal radiation efficiency is little lowered.

Further, in such a separator, the boundary between the surface of the central portion and the inclined surface may be a curved surface. According to such a separator, by joining the edge portion and the central portion smoothly through the curved surface, the cooling fluid can be made to flow smoothly along the surfaces of the thermal radiation portions and between the adjacent thermal radiation portions.

In such a separator, the boundary between the inclined surface and an end face of the edge portion may be a curved surface. According to such a separator, by joining the end face of the edge portion and the inclined surface smoothly, it is ensured that the flow of the cooling fluid is little hindered by the edge portion.

Further, in such a separator, the curvature of a curved surface as the boundary between the surface of the central portion and the inclined surface is greater than the curvature of a curved surface as the boundary between the inclined surface and an end face of the edge portion. According to such a separator, the cooling fluid can be made to flow smoothly along a curved surface as the boundary between the end face of the edge portion and a major surface of the edge portion. Furthermore, it is also possible to suppress the interference between the cooling fluid flowing between the adjacent thermal radiation portions and the cooling fluid flowing in the region near the surfaces of the thermal radiation portions.

In addition, in such a separator, the curvature of a curved surface as the boundary between the surface of the central portion and the inclined surface and the curvature of a curved surface as the boundary between the inclined surface and an end face of the edge portion are set to required values according to the difference in the position at which the thermal radiation portion is disposed in the lamination direction of the power generation bodies and the separator main body portion. According to such a separator, it is possible to control the flow rate of the cooling fluid on the basis of each thermal radiation portion according to the temperatures of the power generation body and the separator main body portion with respect to the lamination direction, and it is possible to set the quantity of heat released from the power generation body and the separator main body portion which are liable to be raised in temperature to be higher than that from the other power generation bodies and separator main body portions.

In the separator according to the present invention in an embodiment, the edge portion of the thermal radiation portion may be a tip end portion of the thermal radiation portion which is so provided as to extend from the side edge portion of the separator main body portion. According to such a separator, when the cooling fluid flows in a direction substantially orthogonal to the direction in which the thermal radiation portion extends, the flow of the cooling fluid is little inhibited by the tip end portion of the thermal radiation portion, and the flow rate of the cooling fluid is therefore not lowered.

In the separator according to the present invention in an embodiment, a surface of the thermal radiation portion may have a required surface roughness so as to reduce the resistance which would inhibit the flow of a cooling fluid for cooling the thermal radiation portion. According to such a separator, it is possible not only by a shape of the thermal radiation portion but also by a surface of the thermal radiation portion to control the flow rate of the cooling fluid, therefore it is possible to sufficiently secure a flow rate and release heat even as the space between the adjacent thermal radiation portions.

According to the present invention in an embodiment, there is provided a fuel cell device including a fuel cell main body in which a power generation body and a separator for making electrical conduction between the power generation body and another power generation body are laminated, wherein the separator includes a separator main body making contact with the power generation bodies, and a thermal radiation portion projectingly provided at a side edge portion of the separator main body portion; and the thickness of at least a part of an edge portion of the thermal radiation portion is set smaller than the thickness of a central portion of the thermal radiation portion. According to such a fuel cell device, a sufficient flow rate can be secured without inhibiting the flow of the cooling fluid when the cooling fluid flows between the adjacent thermal radiation portions. Further, where it is difficult to secure a sufficient space for the flow of the cooling fluid between the adjacent thermal radiation portions, in reducing the size of the fuel cell device, it is possible to maintain a sufficient flow rate by suppressing the interference of the cooling fluid. This makes it possible to achieve stable power generation while suppressing the rise in the temperature of a fuel cell main body.

According to the present invention in an embodiment, there is provided a temperature control method for a fuel cell device, for controlling the temperature of a fuel cell main body in which a power generation body and a separator for making electrical conduction between the power generation body and another power generation body are laminated, wherein the separator includes a separator main body portion making contact with the power generation bodies, and a thermal radiation portion projectingly provided at a side edge portion of the separator main body portion; the thickness of at least a part of an edge portion of the thermal radiation portion is set smaller than the thickness of a central portion of the thermal radiation portion; and a cooling fluid for cooling the fuel cell main body is made to flow in the circumference of the thermal radiation portion. According to such a temperature control method for a fuel cell device, the flow of the cooling fluid is not hindered, so that the cooling fluid is permitted to flow smoothly, and the cooling fluid with a sufficient heat capacity can constantly be taken into the space between the adjacent thermal radiation portions while discharging the cooling fluid having received heat at the time of power generation. Therefore, it is possible to sufficiently release heat from the fuel cell main body through the thermal radiation portions, and to perform stable power generation while suppressing the rise in temperature.

Additional features and advantages of the present invention are described in, and will be apparent from, the following Detailed Description and the figures.

### BRIEF DESCRIPTION OF THE FIGURES

FIG. 1 is an exploded perspective view showing the configuration of a fuel cell device according to an embodiment of the present invention.

FIGS. 2A to 2D show the structure of a casing constituting a fuel cell according to an embodiment in the present invention, in which FIG. 2A is a side view, FIG. 2B is a side view showing another side surface, FIG. 2C is an end view, and FIG. 2D is an end view showing another end face.

FIG. 3 is a perspective view showing the general appearance of a power generation unit constituting a fuel cell device according to a first embodiment of the present invention.

FIG. 4 is an exploded perspective view of a part of the power generation unit constituting the fuel cell device according to the first embodiment of the present invention.

FIGS. 5A and 5B show the basic structure of a separator constituting the fuel cell according to the present invention, in which FIG. 5A is a plan view showing the structure on the face side of the separator, and FIG. 5B is a plan view showing the structure on the back side.

FIG. 6 is a side view, as viewed from one lateral side, of one example of the power generation unit preferable for the fuel cell device according to the present invention in an embodiment.

FIG. 7 is a perspective sectional view schematically showing thermal radiation fins possessed by the power generation unit shown in FIG. 6.

FIG. 8 is a side view, as viewed from one lateral side, of one example of the power generation unit preferable for the fuel cell device according to the present invention in an embodiment.

FIG. 9 is a perspective sectional view schematically showing thermal fins possessed by the power generation unit shown in FIG. 8.

FIG. 10 is a side view, as viewed from one lateral side, of one example of the power generation unit preferable for the fuel cell device according to the present invention in an embodiment.

FIG. 11 is a side view, as viewed from one lateral side, of one example of the power generation unit preferable for the fuel cell device according to the present invention in an embodiment.

FIGS. 12A to 12C are sectional views schematically showing thermal radiation fins preferable for a separator according to the present invention in an embodiment, in which FIG. 12A is a sectional view of a thermal radiation fin with a smooth surface, and FIG. 12C is a sectional view of a thermal radiation fin with a surface having a large surface roughness.

FIG. 13 is a perspective view showing the general appearance of a power generation unit constituting a fuel cell device according to a second embodiment of the present invention.

FIG. 14 is an exploded perspective view of a part of the power generation unit constituting the fuel cell device according to the second embodiment of the present invention.

FIG. 15 is a perspective view showing the general appearance of a separator according to the present invention in an embodiment.

FIG. 16 is a sectional view showing the structure of a thermal radiation fin provided in the separator.

FIGS. 17A and 17B are plan views showing the structure of the separator, in which FIG. 17A is a plan view showing the structure on the face side of the separator, and FIG. 17B is a plan view showing the structure on the back side.

FIGS. 18A and 18B illustrate the flows of air flowing in the vicinity of thermal radiation fins, in which FIG. 18A illustrates the flows of air in the vicinity of thermal radiation fins which are rectangular in sectional shape, and FIG. 18B illustrates the flows of air in the vicinity of thermal radiation fins provided in the separators according to the present invention in an embodiment.

FIG. 19 is a perspective view of another example of the separator according to the present invention in an embodiment.

### DETAILED DESCRIPTION OF THE INVENTION

Now, the separator and the fuel cell device according to the present invention will be described below. The separator according to the present inventor has a characteristic feature in a thermal radiation portion, and, further, the fuel cell device including the separator according to the present invention, i.e., the fuel cell device with a power generation unit mounted therein is a fuel cell device capable of performing power generation while keeping uniform the temperature of the power generation unit by utilizing the characteristic feature of the thermal radiation portion.

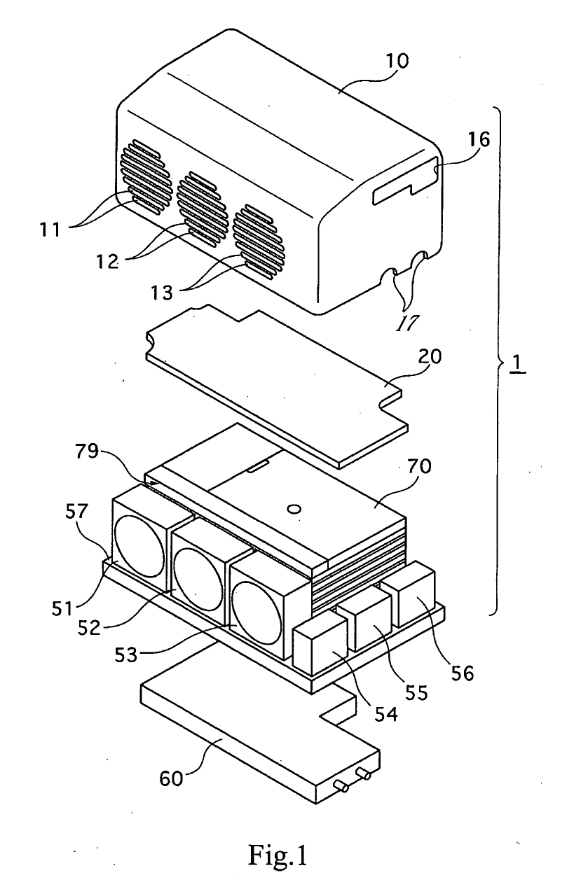

First, the configurations of the separator and the fuel cell device according to the present invention will be described referring to FIGS. 1 to 7. As shown in FIG. 1, the fuel cell device 1 includes a casing 10, a control substrate 20, a power generation unit 70, a cooling fan 51, air supply fans 52 and 53, a hydrogen purge valve 54, a regulator 55, and a manual valve 56. In addition, the fuel cell device 1 receives hydrogen gas supplied from a hydrogen occlusion cartridge 60 occluding the hydrogen gas therein, and performs power generation.

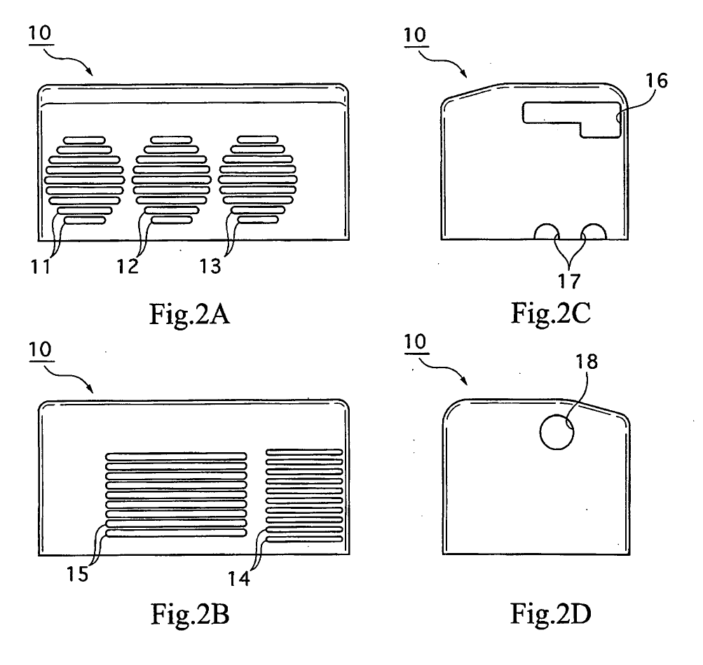

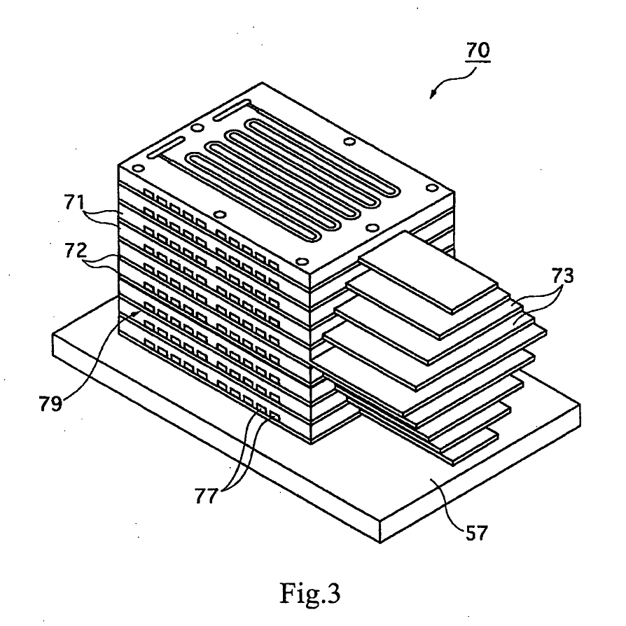

As shown in FIGS. 1 to 2D, the casing 10 is substantially rectangular parallelopiped in outer shape, the inside of the casing 10 is void so that the casing 10 covers various apparatuses mounted in the fuel cell device 1, and the bottom surface of the casing 10 is open. The casing 10 includes exhaust ports 11, 12 and 13, and intake ports 14 and 15, and an end portion of the top face of the casing 10 is an inclined surface extended toward a side surface provided with the exhaust ports 11, 12 and 13. As shown in FIG. 2A, the exhaust port 11 and the exhaust ports 12 and 13 are provided in the side surface of the casing 10 to be arranged side by side, and air having flowed in the fuel cell device 1 so as to cool the power generation unit 70 and air upon the power generation reaction by the power generation unit 70 are exhausted respectively through the exhaust ports 11, 12 and 13. The exhaust ports 11 are discharge ports for discharging air from the fuel cell device 1, for releasing heat from the thermal radiation portions provided in the separators constituting the power generation unit 70. Further, the exhaust ports 11 are each opened in a substantially rectangular shape in the side surface of the casing 10, and are provided in plurality in the vertical direction. The exhaust ports 12 and 13 are discharge ports for discharging the exhaust gas generated upon the power generation by the power generation unit 70. The exhaust ports 12 and 13 are each opened in a rectangular shape in the side view of the casing 10, and are provided in plurality in the vertical direction and along the exhaust ports 11.

As shown in FIG. 2B, the intake ports 14 and 15 are formed in a side surface of the casing 10 which is opposed to the side surface of the casing 10 in which the exhaust ports 11 and the exhaust ports 12 and 13 are formed, and air for cooling the power generation unit 70 and air containing oxygen served to the power generation reaction in the power generation unit 70 are taken into the fuel cell device 1 through the intake ports 14 and 15, respectively. The intake ports 14 are intake ports for taking in air for releasing heat from the thermal radiation portion provided in the separators constituting the power generation unit 70 and are each opened in a substantially rectangular shape in the side surface of the casing 10. The intake ports 14 are provided in plurality in the vertical direction. The intake ports 15 are intake ports for taking in air to be supplied to the power generation unit 70 at the time of power generation conducted by the power generation unit 70 and are each opened in a substantially rectangular shape in the side surface of the casing 10 in the same manner as the intake ports 14. The intake ports 15 are provided in plurality in the vertical direction and along the intake ports 14.

As shown in FIGS. 1 and 2C, one end face of the casing 10 is provided with a connection hole 16 and cutout portions 17 through which to pass wirings for sending and receiving various signals between the fuel cell device 1 and the exterior. The cutout portions 17 are formed at lower parts of the end face in which the connection hole 16 is formed, and wirings for sending and receiving various signals between the exterior and the inside of the fuel cell device 1 are passed through the cutout portions 17. In addition, as shown in FIG. 2D, an end face located on the opposite side of the end face in which the connection hole 16 and the cutout portions 17 are formed is also provided with a connection hole 18 which, like the connection hole 16 and the cutout portions 17, is for passing wirings or the like therethrough.

As shown in FIG. 1, the control substrate 20 is disposed on the upper side in the power generation unit 70, and is provided with a control circuit for controlling various apparatuses constituting the fuel cell device 1. Details of the control circuit are not shown in detail in the figure; for example, a control circuit for the driving of the cooling fan 51 and the air supply fans 52, 53, or a control circuit for the opening/closing operations of the hydrogen purge valve 54, and a voltage conversion circuit such as a DC/DC converter for raising the voltage outputted from the power generation unit 70 may be mounted on the control substrate 20. Further, it is possible to cause a circuit mounted on the control substrate 20 to give commands concerning the driving of various apparatuses by getting various environmental conditions such as temperature and humidity detected by sensors. Besides, while the control substrate 20 is laid out in the fuel cell device 1 in the fuel cell device 1 according to this embodiment, the control substrate 20 may be laid out in the exterior of the fuel cell device 1; for example, the control substrate 20 may be disposed in an electronic apparatus supplied with driving electric power from the fuel cell device 1.

In the next place, the structure of the power generation unit 70 which is a fuel cell main body will be described referring to FIG. 1 and FIGS. 3 to 7.

As shown in FIGS. 1 and 3, the power generation unit 70 is substantially rectangular parallelopiped in shape, and is disposed on a base 57. The power generation unit 70 is composed of power generation cells having joint bodies 72 as power generation bodies sandwiched respectively between nine separators 71, eight such power generation cells being connected in series. The power generation cells are each capable of outputting a voltage of about 0.6 V, so that the power generation unit 70 as a whole can output a voltage of 4.8 V. The power generation unit 70 can supply an electric current of about 2 A. Ideally, therefore, the power generation unit 70 can supply an electric power of 9.6 W. Due to heat generation in the power generation reaction and the like factors, however, the practical output power is about 6.7 W, which is about 70% based on the ideal output power. However, the output power can be further enhanced by control of the quantity of moisture contained in the joint bodies 72 and/or smooth supply of hydrogen gas to the power generation unit 70. In addition, the number of the power generation cells constituting the power generation unit 70 is not limited to eight as in this embodiment; the power generation unit 70 can be composed of a required number of the power generation cells according to the output power needed to drive the relevant electronic apparatus. Opening portions 77 formed in each separator 71 front on a side surface 79 of the power generation unit 70, and a side surface on the opposite side of the side surface 79 of the power generation unit 70 is also provided with opening portions 40 corresponding to the openings 77. Supply and discharge of air to and from the power generation unit 70 are performed through the opening portions 77 and the opening portions 40 fronting on the side surface on the opposite side of the side surface 79 on which the opening portions 77 front.

The separators 71 each include a separator main body portion 74 and a thermal radiation fin 73. The separator main body portions 74 are laminated with the joint bodies 72. The thermal radiation fins 73 are each provided at a side edge portion of the separator main body portion 74, and radiate heat for suppressing the temperature rise in the power generation unit 70 at the time of power generation. The thermal radiation fins 73 have different widths according to the height direction of the power generation unit 70, i.e., according to the position thereof in the lamination direction of the separators 71 and the joint bodies 72. In addition, the length from the side edge portion of the separator main body portion 74, i.e., the length of the thermal radiation fin 73 is equal for the thermal radiation fins constituting the power generation unit 70.

Besides, as shown in FIG. 1, the cooling fan 51 and the air supply fans 52 and 53 are disposed adjacently to each other, along the side surface 79 of the power generation unit 70. The cooling fan 51 causes air to flow from the side of the side surfaces of the thermal radiation fins 73 into the spaces between the thermal radiation fins 73, thereby effecting thermal radiation from the thermal radiation fins 73. In addition, the air supply fans 52 and 53 are disposed to front on the opening portions 77, and cause air to flow in the power generation unit 70 via the opening portions 77.

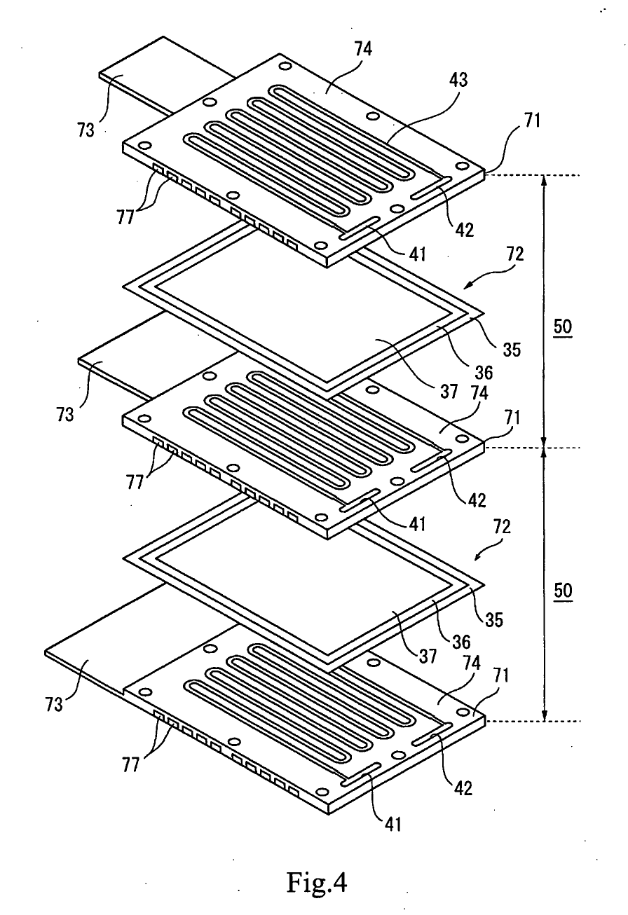

In the next place, the structures of the power generation unit 70 and the separators 71 constituting the power generation unit 70 will be described in detail, referring to FIGS. 4 to 7.

As shown in FIG. 4, the joint bodies 72 sandwiched between the separators 71 each include a solid polymer electrolyte membrane 36 showing ionic conductivity when moistened and electrodes 37 sandwiching the solid polymer electrolyte membrane 36 from both sides. Further, a seal member 35 for sealing between each separator 71 and each joint body 72 when a stack structure is formed is disposed in the vicinity of the periphery of each joint body 72. It suffices for the seal member 35 to be formed of a material which can provide sufficient insulation between a peripheral portion of the separator 71 and a peripheral portion of the joint body 72. As the solid polymer electrolyte membrane 36, for example, a sulfonic acid based solid polymer electrolyte membrane can be used. As the electrode 37, an electrode carrying thereon a catalyst such as platinum for accelerating the power generation reaction may be used. The power generation cells constituting the power generation unit 70 each include two separators 71 and the joint body 72 sandwiched between the separators 71; for example, two power generation cells 50 connected in series are shown in FIG. 4.

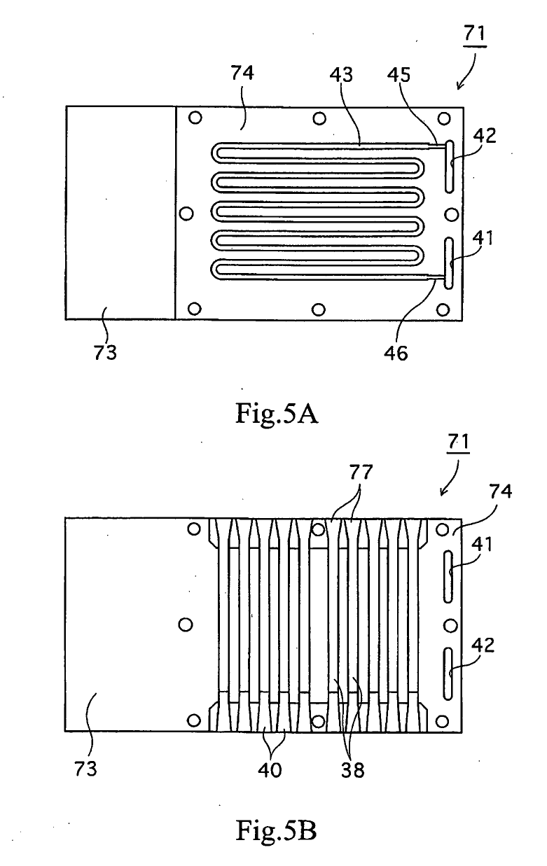

FIGS. 5A and 5B are plan views showing the structure of the separator 71. The separator 71 is provided on both sides thereof with groove portions 38 and 43 respectively, and, upon assembly of the power generation unit 70, the groove portion 43 makes contact with a fuel electrode of the joint body 72, while the groove portions 38 make contact with an air electrode of the joint body 72. In addition, the separator 71 is provided with a supply hole 42 and a discharge hole 41 both connected to the groove portion 43, a connection portion 45 for connecting the groove portion 43 and the supply hole 42 to each other, and a connection portion 46 for connecting the groove portion 43 and the discharge hole 41 to each other. Besides, the thermal radiation portion 73 is provided at a side edge portion of the separator main body portion 74, which is provided with the groove portions 38 and 43.

As shown in FIG. 5A, the groove portion 43 is an in-plane conduit for supplying hydrogen gas, which is a fuel gas, to the joint body 72. The groove portion 43 is formed to meander in the surface of the separator 71 for the purpose of enhancing the efficiency of the power generation reaction, and is so shaped that the hydrogen gas will be supplied to the whole part of the fuel electrode of the joint body 72. The supply hole 42 is a hydrogen gas conduit for supplying the groove portion 43 with the hydrogen gas from a hydrogen gas storage portion such as a hydrogen occlusion cartridge 60 provided in the exterior of the power generation unit 70. The connection portion 45 connects the groove portion 43 and the supply hole 42 to each other, for supplying the hydrogen gas into the groove portion 43. In addition, the connection portion 46 connects the groove portion 43 and the discharge hole 41 to each other, for discharging the hydrogen gas after the power generation reaction from the groove portion 43. The sectional areas of the connection portions 45 and 46 are set smaller than the sectional area of the groove portion 43 at the time when the separators 71 and the joint bodies 72 are assembled into the stack structure; for example, the widths of the connection portions 45 and 46 are set smaller than the width of the groove portion 43. Further, the width of the connection portion 45 is set smaller than the width of the connection portion 46, whereby the width on the side of the inlet of the hydrogen gas into the groove portion 43 is set smaller than the width on the side of the outlet.

The supply holes 42 and the discharge holes 41 are connected between the separators 71 laminated at the time of formation of the stack structure, to form a supply passage for supplying hydrogen gas to each separator 71 and a discharge passage for discharging the hydrogen gas after power generation. When water is accumulated in the groove portion 43, the discharge passage is opened to the atmosphere via the hydrogen purge valve 54 so that a pressure difference between the supply passage side and the discharge passage side is generated for the water accumulated in the groove portion 43, whereby the water can be discharged under the pressure difference. Further, when water is accumulated in the groove portion 43 of an arbitrary one of the separators 71 constituting the stack structure, the pressure difference can instantaneously be generated only in the groove portion 43 with the water accumulated therein, whereby the water can be discharged, and the power generation unit 70 can be stably supplied with hydrogen gas.

As shown in FIG. 5B, the groove portions 38 are formed on the back side of the surface in which the groove portion 43 of the separator 71 is formed, and the groove portions 38 constitute conduits for the flow of oxygen-containing air. The groove portions 38 are formed to extend in the width direction of the separator 71, and open to side surfaces of the separator 71. Further, the groove portions 38 are provided in plurality along the longitudinal direction of the separator 71. In addition, oxygen-containing air is supplied into and exhausted from the groove portions 38 via opening portions 77 and 40 which respectively open to the side surfaces of the separator 71. The widths of the opening portions 77 and 40 may be set somewhat larger than the width of the groove portions 38, and the opening portions 77 and 40 may be so formed that the side walls of the opening portions 77 and 40 are tapered with inclinations against the side walls of the groove portions 38. According to such opening portions 77 and 40, it is possible to reduce the passage resistance against air at the time of taking air into the groove portions 38 or discharging air from the groove portions 38, and to permit air to flow smoothly in the groove portions 38. Besides, the passage resistance can further be reduced by forming the opening portions 77 and 40 so that the opening widths along the height direction of the opening portions 77 and 40 are somewhat greater than the height of the groove portions 38.

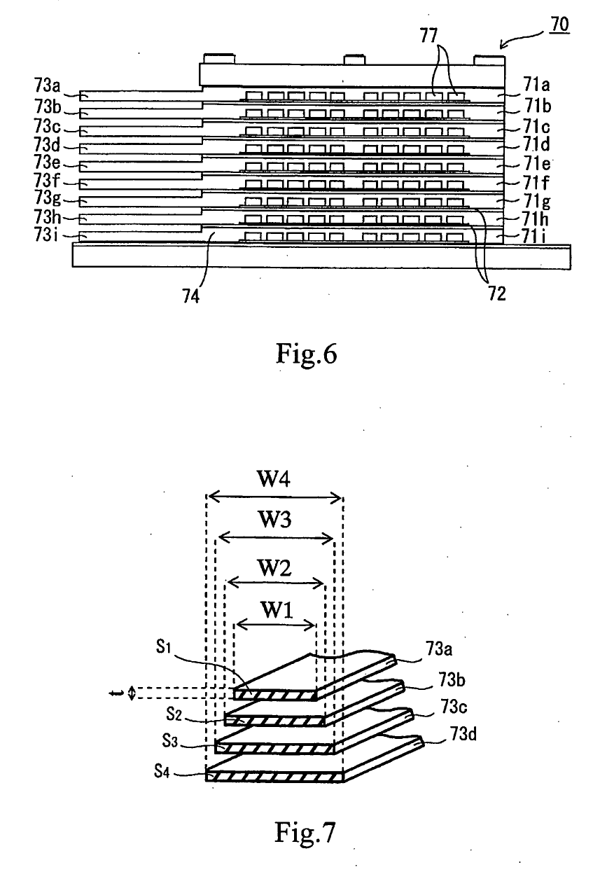

FIG. 6 is a side view, as viewed from a lateral side in the power generation unit 70. FIG. 7 is a perspective sectional view schematically showing a part of the thermal radiation fins provided in the separators constituting the power generation unit 70. Incidentally, the separators 71 are referred to as the separators 71a to 71i in this order according to the position thereof along the direction from the upper side toward the lower side in the power generation unit 70, and the thermal radiation fins 73 are similarly referred to as the thermal radiation fins 73a to 73i, in the following description.

As shown in FIG. 6, the power generation unit 70 includes the separators 71a to 71i and joint bodies 72 which are sandwiched between the separators 71a to 71i to constitute the power generation cells. The separators 71a to 71i have the thermal radiation fins 73a to 73i provided at side edge portions of separator main body portions 74 which makes direct contact with the joint bodies 72.

Side surfaces of the separator main body portions 74 of the separators 71a to 71i are each provided with a plurality of opening portions 77 for supplying air to the joint bodies 72, and air is supplied to the opening portions 77 from air supply fans disposed on the side of a side surface of the power generation unit 70. In addition, by a cooling fan disposed adjacently to the air supply fans along the side surface of the power generation unit 70, air is caused to flow in the periphery of the thermal radiation fins 73a to 73i, to effect thermal radiation from the thermal radiation fins 73a to 73i.

The thermal radiation fins 73a to 73i extend from the side edge portions of the separator main body portions 74 provided in the separators 71a to 71i, and are substantially flat plate-like in shape. The lengths of the thermal radiation fins 73a to 73i, i.e., the lengths from the side edge portions of the separator main body portions 74 to the tip ends of the thermal radiation fins 73a to 73i are substantially equal to each other. The thicknesses of the thermal radiation fins 73a to 73i are also substantially equal, and the thicknesses of the separator main body portions 74 of the separators 71a to 71i are also substantially equal. The thermal radiation fins 73a to 73i are provided in the separator main body portions 74 of the separators 71a to 71i so that the centers of the thermal radiation fins 73a to 73i are substantially coincident with the centers of the separators 71a to 71i with respect to the width direction thereof, i.e., with respect to the depth direction in the figure.

As shown in FIG. 7, of the widths w₁ to w₄ of the thermal radiation fins 73a to 73d, the width w₄ of the thermal radiation fin 73d located substantially at the center of the power generation unit 70 along the lamination direction of the separators 71a to 71i is the greatest, and the width of a thermal radiation fin is smaller as the thermal radiation fin is located on the upper side relative to the thermal radiation fin 73d, i.e., located on the outer side in the power generation unit 70 along the lamination direction. Specifically, on comparison of the widths w₁ to w₄, the width w₄ is the greatest, and the widths w₃, w₂, w₁ are set smaller as the thermal fins are located on the outer side, in this order. Of the separators constituting the power generation unit 70, the one having the greatest width is the thermal radiation fin 73e located roughly at the center of the power generation unit 70, and the thermal radiation fins 73f to 73i located on the lower side of the thermal radiation fin 73e have smaller widths as the thermal radiation fins 73f to 73i are located on the lower side, in this order. Incidentally, while detailed description of the thermal radiation fin 73e and the thermal radiation fins 73f to 73i located on the lower side thereof is omitted, their widths are set with respect to the lamination direction in the same manner as those of the thermal radiation fins 73a to 73d, whereby the quantity of heat radiated is controlled.

The sectional areas S1 to S4 of the thermal radiation fins 73a to 73d are determined according to the magnitude of the widths w₁ to w₄, since the thicknesses of the thermal radiation fins 73a to 73d are equal. The thermal radiation fins 73a to 73d are provided in the condition where the widths w₁ to w₄ of the thermal radiation fins 73a to 73d are so controlled that the sectional area S1 of the thermal radiation fin 73a is the smallest and that the sectional areas of the thermal radiation fins 73b, 73c and 73d are increased in this order. Specifically, as for the thermal fins 73a to 73d, the widths w₁ to w₄ of the thermal radiation fins 73a to 73d are so set that the sectional area S₄ of the thermal radiation fin 73d located near the center of the power generation unit 70 with respect to the lamination direction is the greatest and that the sectional areas S₃, S₂ and S₁ are reduced in this order toward the outside in the power generation unit 70.

The thermal radiation fins 73a to 73d are thermal radiation portions for radiating heat from the separator main body portions 74 of the separators 71a to 71d provided with the thermal radiation fins 73a to 73d, and the quantity of heat transferred from the separator main body portion 74 to the thermal radiation fin is greater as the sectional area of the thermal radiation fin is greater. Therefore, the quantity of heat transferred from the separator main body portion to the thermal radiation fin 73d in the separator disposed near the center of the power generation unit 70 in the lamination direction is increased as compared with that of the thermal radiation fin located on the outer side of the thermal radiation fin 73d. In the power generation cells having the separators 71a to 71d, there is the tendency that the separator located near the center of the power generation unit 70 would be higher in temperature than the other separators, and there is the tendency that the temperature of a separator would be lower as the separator is disposed on the outer side in the power generation unit 70 with respect to the lamination direction. Therefore, when the quantity of heat transferred through the separator located nearer to the center of the power generation unit 70 with respect to the lamination direction is set greater than those of the other separators, it is possible to suppress the temperature rise in the relevant power generation cell, and to make uniform the temperatures of the power generation cells. Also in the power generation cells having the separators 71e to 71i, the sectional area of a thermal radiation fin is set smaller as the thermal radiation fin is located on the outer side in the power generation unit 70, whereby the quantities of heat transferred from the power generation cells to the thermal radiation fins can be controlled.

Besides, the surface areas of the thermal radiation fins 73a to 73d are determined depending on the magnitude of the widths w₁ to w₄, since the thicknesses of the thermal radiation fins 73a to 73d are equal. As for the thermal radiation fins 73a to 73d, the widths w₁ to w₄ of the thermal radiation fins 73a to 73d are so set that the surface area of the thermal radiation fin 73a located on the uppermost side of the thermal radiation portion 70 is the smallest and that the surface area of the thermal radiation fin is increased in the order of the thermal radiation fins 73b to 73d. Specifically, as for the thermal radiation fins 73a to 73d, the widths of the thermal radiation fins 73a to 73d are so set that the surface area of the thermal radiation fin 73d located near the center of the power generation unit 70 in the lamination direction is the greatest and that the surface areas of the thermal radiation fins 73c to 73a are decreased in this order toward the outer side in the power generation unit 70.

At the time of power generation, the separator 71d tends to become higher in temperature as compared with the other separators 71a to 71c, and the separator located on the outer side in the power generation unit 70 tends to become lower in temperature. Therefore, by setting the surface area of the separator located nearer to the center of the power generation unit 70 with respect to the lamination direction to be greater so that the quantity of heat radiated through the relevant thermal radiation fin will be greater than those of the other separators, it is possible to suppress the temperature rise in the power generation cell, to reduce the temperature gradient generated in the inside of the power generation unit 70 with respect to the lamination direction, and to make uniform the temperatures of the power generation cells.

It is considered that a lower portion constituting the power generation unit 70 and including the separators 71e to 71i and the joint bodies 72 slightly differs, in the thermal transfer quantity and the thermal radiation quantity, from an upper portion constituting the power generation unit 70 and including the separators 71a to 71d and the joint bodies 72, since the power generation unit 70 is disposed on the base 57. Like in the case of the thermal radiation fins 73a to 73d, the widths of the thermal radiation fins 73e to 73i are so set that the width of a thermal radiation fin is smaller as the thermal radiation fin is located on the lower side of the center of the power generation unit 70. By thus setting the quantities of heat transferred to the thermal radiation fins 73e to 73i and the quantity of heat radiated through the thermal radiation fins to be smaller on the lower side in the power generation unit 70, it is possible to keep substantially uniform the temperature of the power generation unit 70 as a whole.

In addition, by setting the sectional areas of the thermal radiation fins 73a to 73i according to the positions where the thermal radiation fins 73a to 73i are disposed, it is possible to control the quantities of heat transferred from the separator main body portions 74 to the thermal radiation fins 73a to 73i and the quantities of heat radiated from the thermal radiation fins 73a to 73i, to suppress the rise in the temperature of the power generation unit 70 as a whole, and to make substantially uniform the temperature of the power generation unit 70. According to the power generation unit 70 in which the temperature at the time of power generation is substantially uniform, the condition where a specific power generation cell becomes higher in temperature than the other power generation cells is obviated, and stable power generation can be performed.

Since the thermal radiation fins 73a to 73i are flat plate-like in shape, by setting the widths of the thermal radiation fins to required values, it is possible to set the sectional areas and surface areas thereof accurately and easily, and to control the heat transfer quantity and the thermal radiation quantity.

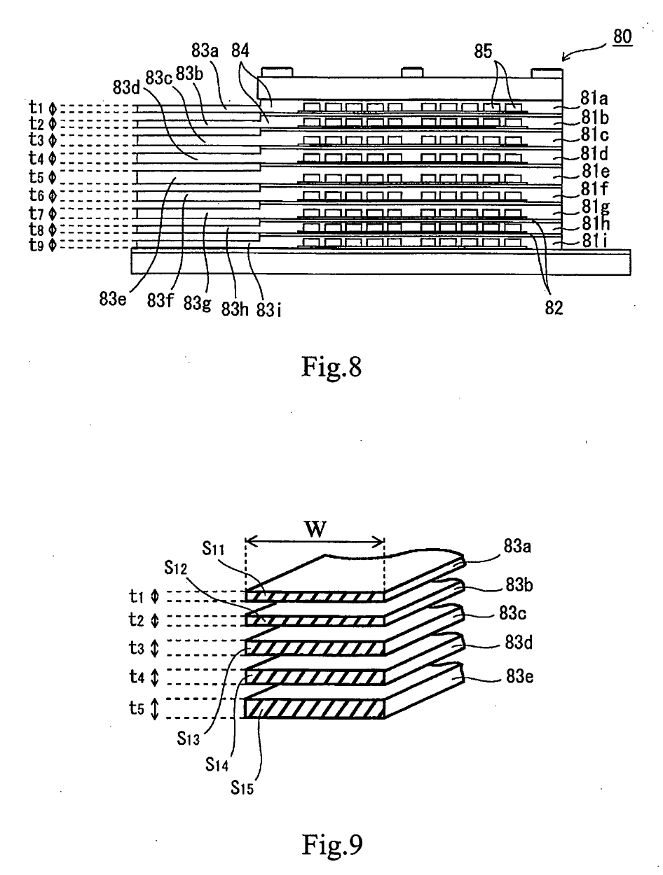

Next, another example of the separator and the fuel cell device according to the present invention will be described referring to FIGS. 8 and 9. FIG. 8 is a side view, as viewed from a lateral side, of a power generation unit 80, and FIG. 9 is a perspective sectional view schematically showing a part of thermal radiation fins constituting the power generation unit 80. The fuel cell device according to this example has substantially the same configuration as that of the fuel cell device 1, and, therefore, description of the configuration of the fuel cell device as a whole will be omitted. Incidentally, the fuel cell device according to this example has a characteristic feature in thermal radiation fins 83a to 83i constituting the power generation unit 80.

As shown in FIG. 8, the power generation unit 80 has a characteristic feature in the thicknesses t₁ to t₉ of the thermal radiation fins 83a to 83i provided respectively in separators 81a to 81i disposed in this order from the upper side toward the lower side in the power generation unit 80, and the thicknesses t₁ to t₉ are set to required values according to the positions of the thermal radiation fins 83a to 83i with respect to the lamination direction of the separators 81a to 81i and joint bodies 82. In addition, side surfaces of the separators 81a to 81i are each provided with a plurality of opening portions 85 for supplying air to the joint bodies 82.

The thicknesses of separator main body portions 84 constituting the separators 81a to 81i are equal to each other, and the thicknesses t₁ to t₉ of the thermal radiation fins 83a to 83i are so set that the thickness of a thermal radiation fin is smaller as the thermal radiation fin is located on the outer side in the power generation unit along the lamination direction. Specifically, the thickness t₅ of the thermal radiation film 83e provided in the separator 81e disposed near the center of the power generation unit 80 is greater than the thicknesses of the thermal radiation fins located on the upper side and the lower side of the thermal radiation fin 83e. The thicknesses t₃, t₄ of the thermal radiation fins 83c, 83d located on the upper side of the thermal radiation fin 83e are equal to each other, and the thicknesses t₁, t₂ of the thermal radiation fins 83a, 83b located on the further upper side are also equal to each other. In addition, the thicknesses t₁, t₂ are smaller than the thicknesses t₃, t₄. Like in the case of the thermal radiation fins located on the upper side of the thermal radiation fin 83e, the thicknesses t₆, t₇ of the thermal radiation fins 83f, 83g located on the lower side of the thermal radiation fin 83e are equal to each other, and the thicknesses t₈, t₉ of the thermal radiation fins 83h, 83i located on the further lower side are also equal to each other. Besides, the thicknesses t₈, t₉ are smaller than the thicknesses t₆, t₇. The widths W of the thermal radiation fins 83a to 83i are equal for all the thermal radiation fins 83a to 83i, and the lengths of the thermal radiation fins 83a to 83i are also equal for all of the thermal radiation fins 83a to 83i.

Thus, the thickness of the thermal radiation fin is set smaller in order from the center of the power generation unit 80 toward the outer side along the lamination direction, whereby the sectional area of the thermal radiation fin is set smaller in order from the center of the power generation unit 80 toward the outer side. In addition, the thickness t₅ of the thermal radiation fin 83e may be set greater than those of the other thermal radiation fins, and the thicknesses of the thermal radiation fins disposed on the outer side in the power generation unit 80 may be set smaller in order.

Referring to FIG. 9, the relationships among the sectional areas of the thermal radiation fins 83a to 83e located at an upper portion of the power generation unit 80 will be described. Incidentally, the sectional areas of the thermal radiation fins 83a to 83e are denoted by S₁₁, to S₁₅. Since the widths W of the thermal radiation fins 83a to 83e are equal, the sectional areas S₁₁ to S₁₅ are determined by the thicknesses t₁ to t₅, the sectional area S₁₅ is the greatest, and the sectional areas S₁₁, to S₁₄ of the other thermal radiation fins 83a to 83d are set smaller than the sectional area S₁₅. In addition, the sectional areas S₁₃ and S₁₄ are set equal to each other, and the sectional areas S₁₁ and S₁₂ are also set equal to each other. The sectional areas S₁₁ and S₁₂ are set smaller than the sectional areas S₁₃ and S₁₄.

The sectional area S₁₅ of the thermal radiation fin 83e provided in the separator 81e which is disposed near the center of the power generation unit 80 and which tends to show the greatest temperature rise in the power generation unit 80 is set to be somewhat greater than the sectional areas S₁₁ to S₁₄ of the other thermal radiation fins 83a to 83e, whereby the quantity of heat transferred from the separator main body portion 84 of the separator 81e can be enhanced as compared with those of the other separators. Further, the sectional areas S₁₃ and S₁₁ of the thermal radiation fins 83c and 83a located on the upper side of the thermal radiation fin 83e are set smaller sequentially, whereby the quantities of heat transferred from the separator main body portions 84 of the separators 81c and 81a provided respectively with the thermal radiation fins 83c and 83a can be suppressed, more as the thermal radiation fin is located on the outer side relative to the separator 81e.

Thus, with the quantities of heat transferred from the separator main body portions 84 of the separators 81a to 81i to the thermal radiation fins 83a to 83i being controlled according to the positions of the separators 81a to 81i with respect to the lamination direction, it is possible to permit the power generation unit 80 to generate electric power while keeping uniform the temperatures of the power generation cells including these separators, irrespectively of the positions of the separators. Particularly, in the power generation unit 80, by setting the thicknesses of the thermal radiation fins so that the quantity of heat transferred is sequentially reduced as the separator is located on the outer side of the power generation unit 80, the quantity of heat transferred by the thermal radiation fin 83e located at the central portion and more liable to be raised in temperature can be enhanced as compared with those by the other thermal radiation fins. This makes it possible to perform power generation while keeping uniform the temperature of the power generation unit 80 easily, without modifying the design of the power generation unit 80.

In addition, by controlling the thicknesses t₁ to t₉ of the thermal radiation fins 83a to 83i constituting the power generation unit 80, the surface areas of the thermal radiation fins 83a to 83i can be controlled according to the positions of the thermal radiation fins 83a to 83i. Since the heat transferred from the separator main body portions 84 to the thermal radiation fins 83a to 83i are radiated to the exterior from the surfaces of the thermal radiation fins 83a to 83i, the quantity of heat thus radiated is greater as the surface area of the thermal radiation fin is greater.

Specifically, as for the upper portion of the power generation unit 80, each thermal radiation fin is provided in each separator main body portion 84 so that the surface area of the thermal radiation fin 83a is the smallest, and the surface area is increased in the order to the thermal radiation fins 83b, 83c and 83d. In other words, the quantity of heat radiated from the thermal radiation fin 83a located on the uppermost side in the power generation unit 80 is the smallest, and the quantity of heat radiated from the thermal radiation fin 83d located roughly at the center of the power generation unit 80 is the greatest. As a result, when the power generation unit 80 performs power generation, the quantity of heat released from the separator 81d tending to be raised in temperature as compared with the other separators can be set greater than those from the other separators, and the rise in the temperature of the power generation cell included of the separator 81d can be suppressed.

With the surface areas of the thermal radiation fins 83a to 83c controlled according to the position along the lamination direction, it is possible to control the quantities of heat radiated, and to make uniform the temperatures of the separators 81a to 81d. As for the lower portion of the power generation unit 80, like in the case of the upper portion, the surface area of a thermal radiation fin is smaller and the quantity of heat radiated from the thermal radiation fin is more suppressed as the thermal radiation fin is located on the outer side in the power generation unit 80. Since the thermal radiation fins 83a to 83i are flat plate-like in shape, the thermal radiation fins 83a to 83i are rectangular in sectional shape, and, by setting the widths or thicknesses of the thermal radiation fins 83a to 83i to required values, it is possible to accurately and easily set the surface areas of the thermal radiation fins 83a to 83i, and to control the quantities of heat radiated from the thermal radiation fins 83a to 83i.

Incidentally, while each pair of thermal radiation fins, such as the thermal radiation fins 83a and 83b, have the same thickness, the thicknesses of the thermal radiation fins may be set to required values according to the power generation conditions in the power generation unit 80 so as to make uniform the temperature of the power generation unit 80, taking into account the output power, the size of the power generation unit 80, the thermal conductivities of the materials constituting the power generation unit 80, and the like.

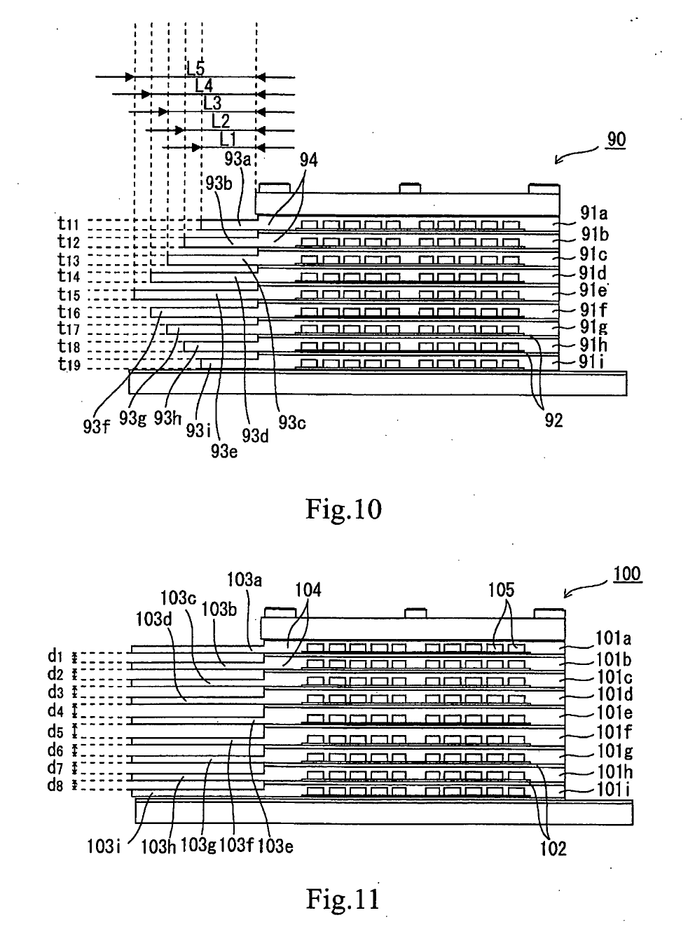

In the next place, referring to FIG. 10, a further example of the separator and the fuel cell device according to the present invention will be described. FIG. 10 is a side view, as viewed from a lateral side, of a power generation unit 90. Incidentally, the fuel cell device in this example also has substantially the same configuration as the fuel cell device 1, and, therefore, the power generation unit 90 will be described in detail. The power generation unit 90 has substantially the same structure as the power generation unit 70, and has a characteristic feature in thermal radiation fins 93a to 93i.

As shown in FIG. 10, the power generation unit 90 includes separators 91a to 91i laminated in this order from the upper side, with joint bodies 92 sandwiched between the separators 91a to 91i. The thermal radiation fins 93a to 93i provided in the separators 91a to 91i are equal in width. The power generation unit 90 has substantially the same structure as the power generation unit 70, and the lengths L1 to L9 of the thermal radiation fins 93a to 93i provided in the separators 91a to 91i constituting the power generation unit 90 are set at required values with respect to the lamination direction. Particularly, the thermal radiation fin 93e provided in the separator 91e, which tends to show a greatest temperature rise among the separators 91a to 91i constituting the power generation unit 90 and which is disposed at the center of the power generation unit 90, has the greatest length. The thermal radiation fins located on the upper side and the lower sides of the separator 91e are set smaller in length than the thermal radiation fin 93e. Incidentally, the lengths L6 to L9 are equal to the lengths L4 to L1, respectively, and are not indicated in the figure.

To be more specific, the thermal radiation fins 93a to 93d provided to extend from side edge portions of the separator main body portions 94 roughly in parallel along the thermal radiation fin 93e have lengths L1 to L4 which are enlarged in the order of the thermal radiation fins 93a to 93d. The lengths L6 to L9 of the thermal radiation fins 93f to 93i located on the lower side of the thermal radiation fin 93e are smaller than the length L5 of the thermal radiation fin 93e, and are reduced in the order of the lengths L6 to L9. Therefore, as for the thermal radiation fins 93a to 93i, the surface area of the thermal radiation fin 93e is the greatest, and the surface areas of the thermal radiation fins 93a to 93d located on the upper side of the thermal radiation fin 93e are greater in the order of the thermal radiation fins 93e to 93a. Besides, the surface areas of the thermal radiation fins 93f to 93i disposed on the lower side of the thermal radiation fin 93e are greater in the order of the thermal radiation fins 93f to 93i.

By constituting the power generation unit 90 by use of the separators 91a to 91i provided respectively with such thermal radiation fins 93a to 93i, the quantities of heat released from the power generation cells included of the separators 91a to 91i are controlled by the surface areas of the thermal radiation fins 93a to 93i, and power generation can be performed while keeping uniform the temperature of the power generation unit 90 with respect to the lamination direction. The combination of the lengths of the thermal radiation fins may be any combination that makes it possible to keep the power generation unit 90 at a substantially uniform temperature, and is naturally not limited to the length combination according to this example.

Here, in the case where the thicknesses t₁₁ to t₁₉ of the thermal radiation fins 93a to 93i are equal to each other, the sectional areas of the thermal radiation fins 93a to 93i are uniform, since the widths of the thermal radiation fins 93a to 93i are equal to each other. In the case where the thermal radiation fins 93a to 93i are uniform in sectional area and are different in length only, the thermal resistance in the inside of each thermal radiation fin results in that the proportions of heat transmitted from the side edge portions of the separator main body portion 94 to the tip ends of the thermal radiation fins 93a to 93i become nonuniform. Therefore, enlarging the surface area of a thermal radiation fin may fail to obtain a thermal radiation quantity corresponding to the increase in surface area.

In view of this, by controlling the thicknesses t₁₁ to t₁₉ of the thermal radiation fins 93a to 93i, the surface areas of the thermal radiation fins 93a to 93i are controlled, the thermal resistances are controlled, and the heat transfer quantities are controlled. For example, the thickness t₁₅ of the thermal radiation fin 93e is set to be the greatest, thereby reducing the thermal resistance, and the thicknesses of the thermal radiation fins located on the upper side and the lower side of the thermal radiation fin 93e, i.e., the thermal radiation fins located on the outside relative to the center of the power generation unit 90 are set to be smaller. In the power generation unit 90 according to this example, for example, the thickness t₁₅ is controlled to be the greatest, and the thicknesses of the thermal radiation fins located on the upper side and the lower side of the thermal radiation fin 93e are so set that the thickness of a thermal radiation fin is smaller as the thermal radiation fin is located on the outer side in the power generation unit. By thus controlling the thermal resistances of the thermal radiation fins 93a to 93i and setting the surface areas of the thermal radiation fins 93a to 93i according to the positions of the thermal radiation fins 93a to 93i with respect to the lamination direction, the temperature of the power generation unit 90 can be controlled so as to obtain a substantially constant temperature throughout the power generation unit 90.

Next, referring to FIG. 11, yet another example of the separator and the fuel cell device according to the present invention will be described. Incidentally, the fuel cell device according to this example also has substantially the same configuration as the fuel cell device 1, and, therefore, only a power generation unit 100 will be described in detail. The power generation unit 100 has substantially the same structure as the power generation unit 70, and has a characteristic feature in the intervals between thermal radiation fins 103a to 103i.

FIG. 11 is a side view, as viewed from a lateral side, of the power generation unit 100. As shown in FIG. 11, while the power generation unit 100 has substantially the same structure as that of the power generation unit 70, the interval between an adjacent pair of the thermal radiation fins 103a to 103i with respect to the lamination direction of joint bodies 102 and separators 101a to 101i is set to a predetermined interval based on the position of the adjacent pair of the thermal radiation fins 103a to 103i. In addition, the power generation unit 100 has substantially the same structure as the power generation unit 70, and a plurality of opening portions 105 for supplying air to the joint bodies 102 are formed in a side surface of a separator main body portion 104 constituting each of the separators 101a to 101i.

The power generation unit 100 includes the separators 101a to 101i and the joint bodies 102 sandwiched between the separators 101a to 101i. The separators 101a to 101i are provided respectively with the thermal radiation fins 103a to 103i at side edge portions of the separator main bodies 104 thereof. The intervals between the adjacent pairs of the thermal radiation fins 103a to 103i with respect to the lamination direction are denoted by d₁ to d₈, in this order from the upper side of the power generation unit 100.

Like in the case of the power generation unit 70 described above referring to FIGS. 1 to 7, the power generation unit 100 is supplied with air from a lateral side of the power generation unit 100, and the air flows in the spaces between the thermal radiation fins 103a to 103i. Heat is transferred from the thermal radiation fins 103a to 103i to the air flowing between the thermal radiation fins 103a to 103i, the air is discharged to the exterior of the fuel cell device and, simultaneously, heat is discharged.

The intervals d₁ to d₈ are larger for the adjacent thermal radiation fins located nearer to the center of the power generation unit 100, and decrease toward the outer sides in the power generation unit 100. For example, in the power generation unit 100, the interval d₅ between the adjacent thermal radiation fins 103e and 103f located roughly at the center of the power generation unit 100 is the greatest, and the interval is decreased toward the upper side in the order of the intervals d₄, d₃, d₂ and d₁. Also, in the thermal radiation fins 103f to 103i located on the lower side in the power generation unit 100, the intervals d₆ to d₈ between the adjacent thermal radiation fins are decreased in the order of the intervals d₆, d₇ and d₈. Therefore, the flow rate of air flowing between the thermal radiation fins differs depending on the magnitude of the intervals d₁ to d₈, whereby the quantity of heat radiated from the thermal radiation fin provided in the separator constituting the power generation cell liable to be raised in temperature in the power generation unit 100 can be set greater than those from the other thermal radiation fins.

Further, the intervals d₁ to d₄ are so controlled that the intervals d₁ to d₄ are smaller than the interval d₅ and that the interval between the adjacent thermal radiation fins increases in the order of the intervals d₂ to d₄. The intervals d₆ to d₈ between the adjacent pairs of the thermal radiation fins 103f to 103i located on the lower side of the thermal radiation fin 103e are set to be smaller than the interval d₅ and to decrease in the order of d₆ to d₈. In such a power generation unit 100, the flow rate of air flowing in the interval d₅ between the thermal radiation fins 103e and 103f is the highest, and the flow rate of air decreases in the order of the intervals d₄ to d₁. Further, the flow rate of air flowing in the intervals d₆ to d₈ decreases, according to the magnitudes of the intervals d₆ to d₈.

In other words, the quantities of heat radiated from the thermal radiation fins 103a to 103i are controlled according to the flow rates of air, or the magnitudes of the intervals d₁ to d₈, and the quantity of heat radiated from the thermal radiation fins 103d and 103e disposed at the center of the power generation unit 100 is greater than those from the other thermal radiation fins.

Further, since the intervals d₁ to d₈ are so set that the flow rate of air is lower on the outer side in the power generation unit 100, the power generation cells disposed nearer to the center of the power generation unit 100 and more liable to be raised in temperature at the time of power generation are enhanced in thermal radiation quantity as compared with the other power generation cells, and it is possible to make substantially uniform the temperature of the power generation unit 100 along the lamination direction.

The intervals d₁ to d₈ can be controlled by setting the thicknesses of the separator main body portions 104 and the thicknesses of the thermal radiation fins to required values. For example, the intervals d₁ to d₈ can be controlled by setting uniform the thicknesses of the separator main body portions 104 of the separators 101a to 101i and providing the separator main body portions 104 with the thermal radiation fins controlled in thickness. In addition, the separators 101a to 101i are so configured that the lower surfaces of the separator main body portions 104 and the lower surfaces of the thermal radiation fins 103a to 103i are flush with each other, respectively, so that a power generation unit 100 having the required intervals d₁ to d₈ can be configured by only controlling the differences between the thicknesses of the separator main bodies 104 and the thicknesses of the thermal radiation fins 103a to 103i.

While the power generation unit and the separators suited to make temperature substantially uniform by controlling the outer sizes of the thermal radiation fins and thereby controlling the sectional areas or surface areas of the thermal radiation fins or the intervals between the adjacent pairs of the thermal radiation fins have been described above referring to FIGS. 1 to 11, the outer sizes are not limited to the combinations in the above-described examples; naturally, it suffices to form thermal radiation fins suitable for securing required thermal radiation quantities and heat transfer quantities according to the positions of the separators disposed in a power generation unit, by controlling the widths, lengths and thicknesses of the thermal radiation fins and the thicknesses of the separator main body portions in combination.

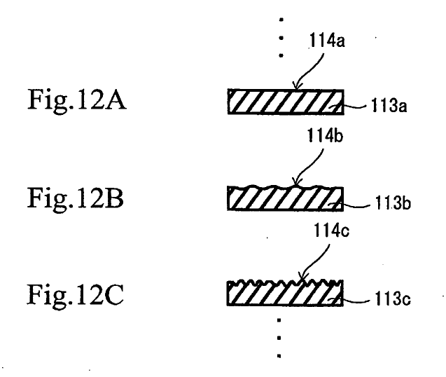

Next, referring to FIGS. 12A to 12C, a yet further example of the separator and the fuel cell device according to the present invention will be described. Incidentally, the fuel cell device according to this example also has substantially the same configuration as that of the fuel cell device 1, and a power generation unit mounted in the fuel cell device according to this example also has substantially the same structure as that of the power generation unit 70. In the separator and the power generation unit in this example, a characteristic feature lies in the surfaces of thermal radiation fins, and, therefore, the surface of the thermal radiation fin will be described in detail, whereas description of detailed configurations of the fuel cell device and the power generation unit will be omitted.

FIGS. 12A to 12C are sectional views of a part of a thermal radiation fin constituting the power generation unit according to this example and being located with respect to the lamination direction of separators and joint bodies. According to the separator and the fuel cell device in this example, the temperature of the power generation unit can be kept substantially uniform by utilizing the difference in the surface roughness of thermal radiation fins or in the surface treatment applied to the thermal radiation fins, without needing modifications in the size or design of the power generation unit.

As shown in FIGS. 12A to 12C, the thermal radiation fins 113a to 113c are thermal radiation fins provided in separators constituting a power generation unit which is mounted in the fuel cell device according to this example. The thermal radiation fin 113a is located nearly at the center of the power generation unit with respect to the lamination direction, and the thermal radiation fins 113b and 113c are located sequentially on the outer side of the thermal radiation fin 113a in the power generation unit. In addition, the thermal radiation fins 113a to 113c are equal in width, length and thickness. While the surface 114a of the thermal radiation fin 113a shown in FIG. 12A is substantially smooth, the surface 114b of the thermal radiation fin 113b shown in FIG. 12B is largely rugged, to have a large surface roughness. Further, the surface 114c of the thermal radiation fin 113c shown in FIG. 12C is larger in surface roughness than the surface 114b. The surface areas of the thermal radiation fins 113a to 113c are equal to the surface area calculated from the outer sizes of the thermal radiation fin, i.e., the width, thickness and length of the thermal radiation fin, but the substantial surface areas are different because the surfaces 114a to 114c are different in surface roughness.

Specifically, the surface area of the thermal radiation fin 113b is substantially larger than the surface area of the thermal radiation fin 113a, and the substantial surface area thereof can be enlarged as compared with the surface area calculated from the outer sizes of the thermal radiation fin 113b. Similarly, the surface area of the thermal radiation fin 113c is substantially larger than the surface area of the thermal radiation fin 113b. Therefore, even in the case of thermal radiation fins having equal outer sizes, the thermal radiation fin having a larger surface roughness can have a larger substantial surface area, and the quantity of heat radiated from the surface can be enlarged according to the magnitude of the surface area. Further, an increase in the surface roughness can enhance the thermal emissivity. In other words, the thermal radiation fins 113a to 113c can be set to have required thermal emissivity values according to the difference in the position with respect to the lamination direction. Accordingly, in the case of this example, by setting the thermal emissivity of a thermal radiation fin to be lower as the thermal radiation fin is disposed on the outer side in the power generation unit, the quantity of heat radiated from each thermal radiation fin can be controlled so as to make uniform the temperature of the power generation unit as a whole.

By a method in which the separators provided with thermal radiation fins thus differing in surface roughness are laid out at required positions in the power generation unit, the quantity of heat radiated from each thermal radiation fin can be enhanced as compared with those from the other separators. In other words, it suffices that thermal radiation fins having required surface roughnesses are so disposed as to make substantially uniform the temperature of the power generation unit. For example, by a method in which the separator constituting the power generation cell disposed nearly at the center of the power generation unit is provided with a thermal radiation fin having a large surface roughness and the surface roughnesses of thermal radiation fins located on the outer side are controlled to be smaller, it is possible to achieve stable power generation while making substantially uniform the temperature of the power generation unit along the lamination direction. In addition, the outer sizes of the thermal radiation fins are not controlled, so that it is unnecessary to change the size or design of the power generation unit.

Besides, the thermal emissivity of a thermal radiation fin can be controlled also by a surface treatment of the thermal radiation fin. For example, by subjecting the surfaces of the thermal radiation fins to different plating treatments, it is possible to utilize the difference or differences in thermal emissivity among the plating films. These treatments are not limitative, and an arbitrary surface treatment can be applied to the thermal radiation fin inasmuch as the surface treatment enables control of thermal emissivity. By such a method it is possible to control the quantities of heat radiated from the thermal radiation fins, and to achieve stable power generation while making substantially uniform the temperature of the power generation unit along the lamination direction. Therefore, like in the case of controlling the surface roughness, the outer sizes of the thermal radiation fins are not controlled, so that it is unnecessary to change the size or design of the power generation unit.

Further, according to a temperature control method for a fuel cell device according to the present invention, it is possible, in radiating heat while causing air to flow in the circumference of thermal radiation fins, to control the thermal radiation quantity according to the positions at which the thermal radiation fins are disposed, and to perform power generation so as to make substantially uniform the temperature of the power generation unit having a stack structure. Specifically, the thermal radiation quantity can be controlled by setting the surface areas and/or sectional areas of thermal radiation fins, the intervals between the adjacent thermal radiation fins, and the thermal emissivities of the thermal radiation fins to required values.

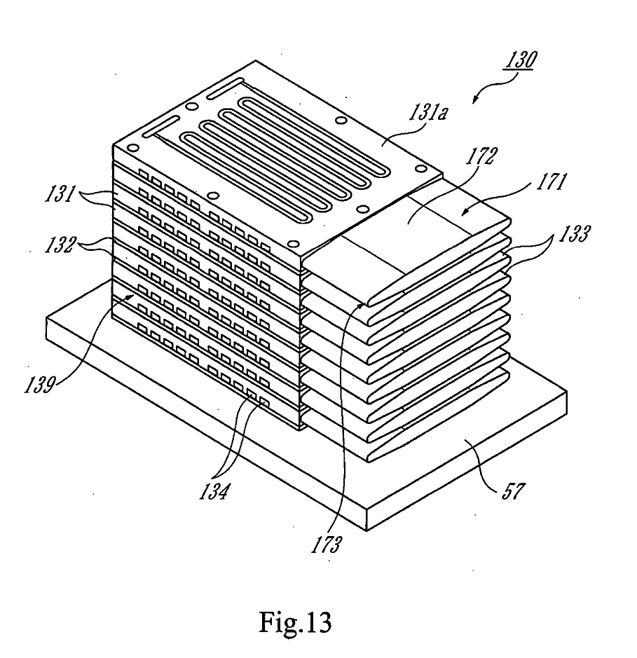

A separator, a fuel cell device, and a temperature control method for a fuel cell device according to the present invention will be described referring to FIG. I and FIGS. 13 to 19. The fuel cell device 1 has the same configuration as the fuel cell device shown in FIG. 1 as described above.

Referring to FIGS. 1 and 13, the structure of a power generation unit 130 different in configuration from the power generation unit described referring to FIG. 3 will be described. FIG. 13 is a perspective view of the power generation unit 130. The power generation unit 130 shown in FIG. 13 corresponds to the power generation unit 70 shown in FIG. 3.

As shown in FIGS. 1 and 13, the power generation unit 130 is substantially rectangular parallelopiped in shape, and is disposed on a base 57. The power generation unit 130 includes power generation cells having joint bodies 132 as power generation bodies sandwiched between nine separators 131, eight such power generation cells being connected in series. Each of such power generation cells can output a voltage of about 0.6 V, so that the power generation unit 130 as a whole can output a voltage of 4.8 V. The power generation unit 130 can supply an electric current of about 2 A, and the output power is 9.6 W, ideally. Due to heat generation in the power generation reaction and other factors, however, the practical output power is about 6.7 W, which is about 70% based on the ideal output power. However, the output power can further be enhanced by control of the quantity of moisture contained in the joint bodies 132 or smooth supply of hydrogen gas to the power generation unit 130. In addition, the number of the power generation cells for forming the power generation unit 130 is not limited to eight as in this embodiment; the power generation unit 130 may be formed by use of a required number of the power generation cells according to the output power needed for driving an electronic apparatus concerned. Opening portions 134 formed in each separator 131 front on a side surface 139 of the power generation unit 130, and, as will be described later, a side surface on the opposite side of the side surface 139 of the power generation unit 130 is also provided with opening portions 140 corresponding to the opening portions 134. Supply and discharge of air to and from the power generation unit 130 are performed through the opening portions 134 and the opening portions 140 fronting on the side surface on the opposite side of the side surface 139 on which the opening portions 134 front.

In addition, as shown in FIGS. 1 and 13, a cooling fan 51 and air supply fans 52, 53 are arranged adjacent to each other along the side surface 139 of the power generation unit 130. The separators 131 constituting the power generation unit 130 are so laminated that the joint bodies 132 as the power generation bodies are sandwiched between the separators 131, and a thermal radiation fin 133 is provided at a side edge portion of each separator main body portion 131a making contact with the joint bodies 132. The thermal radiation fins 133 each include a central portion 172 substantially rectangular in sectional shape, and edge portions 171 substantially tapered in sectional shape. The edge portions 171 respectively front on the inlet side and the outlet side with respect to the flow of air between the thermal radiation fins 133 adjacent to each other in the lamination direction of the separators 131 and the joint bodies 132. The cooling fan 51 causes air to flow in the spaces between the thermal radiation fins 133 from a lateral side of the thermal radiation fins 133, to effect thermal radiation from the thermal radiation fins 133. The cooling fan 51 discharges air having received the heat transferred from the thermal radiation fins 133, and air having a sufficient heat capacity is supplied from the exterior of the fuel cell device into the spaces between the thermal radiation fins 133, whereby air flows between the thermal radiation fins 133. The substantially tapered sectional shape of the edge portions 171 permits smoother flow of air, as compared with the case where the edge portions 171 are rectangular in sectional shape. Incidentally, the power generation unit 130 shown in FIG. 13 is shown in the condition where an insulation member disposed on the uppermost side of the power generation unit 70 shown in FIG. 1 has been removed.

By the forced flow of air between the thermal radiation fins 133 thus effected by the cooling fan 51, it is possible to substantially obviate the lowering in the efficiency of thermal radiation from the thermal radiation fins 133, and to suppress the temperature rise in the power generation unit 130, thereby permitting the power generation unit 130 to perform stable power generation. Further, since the edge portions 171 of the thermal radiation fins 133 provided in the power generation unit 130 according to this embodiment are substantially tapered in sectional shape, the flow rate of air supplied to and discharged from the areas between the thermal radiation fins 133 by the cooling fan 51 is little lowered. Furthermore, when the cooling fan 51 and the air supply fan 52, 53 are driven by the output power from the power generation unit 130, the power generation by the power generation unit 130 and the driving of the cooling fan 51 and the air supply fans 52, 53 can be performed stably, power loss in the cooling fan 51 can be suppressed, and the entire system of the fuel cell device 1 with the power generation unit 130 and the relevant electronic apparatus mounted therein or thereon can be driven stably.

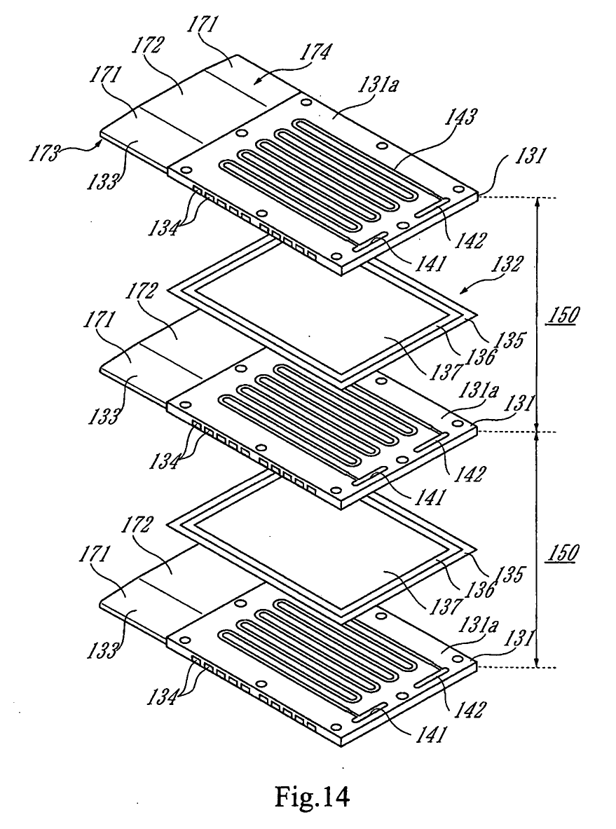

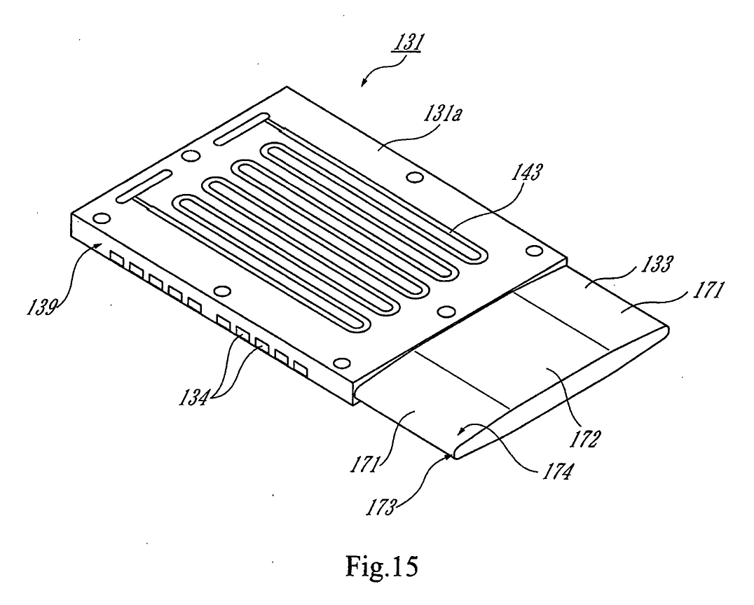

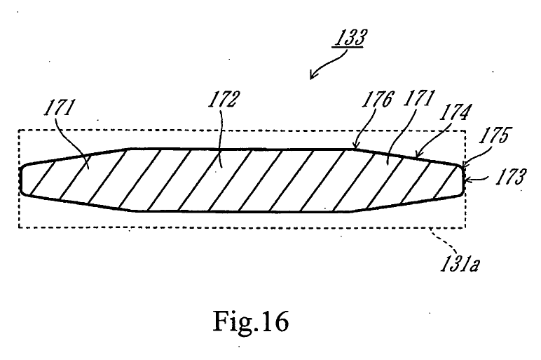

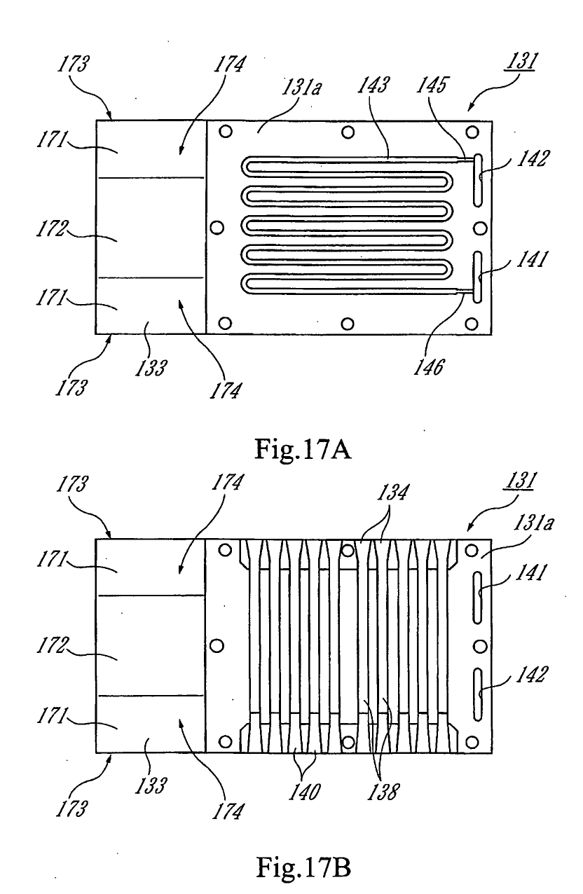

In the next place, the structures of the power generation unit 130 and the separators 131 constituting the power generation unit 130 will be described more in detail, referring to FIGS. 14 to 17A and 17B. FIG. 14 is an exploded perspective view of the power generation unit 130, FIG. 15 is a perspective view of the separator 131, FIG. 16 is a sectional view of the thermal radiation fin 133, and FIGS. 17A and 17B are plan views of the separator 131.

As shown in FIG. 14, the power generation unit has a stack structure in which a plurality of power generation cells 150 having the separators 131 and the joint bodies 132 laminated on each other are stacked. The power generation cells 150 constituting the power generation unit 130 are each composed of two separators 131 and the joint body 132 sandwiched between the separators 131; for example, two power generation cells 150 connected in series are shown in FIG. 14.

The separators 131 each include the separator main body 131 a provided with a groove portion 143 in its surface, and the thermal radiation fin 133 provided at a side edge portion of the separator main body portion 131a. The joint body 132 sandwiched between the separator main body portions 131a includes a solid polymer electrolyte membrane 136 showing ionic conductivity when moistened, and electrodes 137 sandwiching the solid polymer electrolyte membrane 136 from both sides. Further, a seal member 135 for sealing between the separator main body portion 131a and the joint body 132 when the stack structure is formed is disposed in the vicinity of the periphery of the joint body 132. The seal member 135 may be formed of any material that can provide sufficient insulation between a peripheral portion of the separator 131 a and a peripheral portion of the joint body 132. As the solid polymer electrolyte membrane 136, for example, a sulfonic acid based solid polymer electrolyte membrane can be used. As the electrode 137, an electrode carrying thereon a catalyst such as platinum for accelerating the power generation reaction may be used.

As shown in FIG. 15, the separator 131 includes the separator main body portion 131a provided with the groove portion 143, and the thermal radiation fin 133 provided at a side edge portion of the separator main body portion 131a. Edge portions 171 of the thermal radiation fin 133 each have an end face 173 faced substantially orthogonally to the flow of air, and inclined surfaces 174 inclined against the surface of a central portion 172 of the thermal radiation fin 133, and the edge portions 171 are substantially tapered in sectional shape. One of the edge portions 171 fronts on the inlet side with respect to air flowing between the thermal radiation fins 133 adjacent to each other along the lamination direction, and the other of the edge portions 171 fronts on the inlet side with respect to the air. The inclined surfaces 174 fronting respectively on the upper side and the lower side of the surfaces of the edge portions 171 extend from the side edge portion of the separator main body portion 131a to a tip end portion of the thermal radiation fin 133, and the thermal radiation fin 133 as a whole can reduce the resistance to air.

Referring to FIG. 16, the thermal radiation fin 133 will be described more in detail. The central portion 172 of the thermal radiation fin 133 is substantially rectangular in sectional shape, and the upper surface and the lower surface of the central portion 172 are substantially parallel to the upper surface and the lower surface of the separator main body portion 131a. The edge portions 171 of the thermal radiation fin 133 are substantially tapered in sectional shape, and the edge portions 171 each have the end face 173 faced substantially orthogonally to the flow of air, and the inclined surfaces 174 connecting the end face 173 to the upper surface and the lower surface of the central portion 172 respectively. The end face 173 and the inclined surfaces 174 are connected by curved surfaces 175, and the inclined surfaces 174 and the upper and lower surfaces of the central portion 172 are connected by curved surfaces 176, to form the surface of the thermal radiation fin 133 continuous over the range from the end face 173 to the upper and lower surfaces of the central portion 172. The curvature R of the curved surface 176 is set greater than the curvature r of the curved surface 175. Between the adjacent thermal radiation fins 133, the edge portion 171 fronting on the inlet side with respect to the flow of air is substantially tapered in sectional shape, whereby the pressure loss relating to the flow of air, i.e., the resistance which would make it difficult for air to flow can be reduced, as in the case where the edge portion 171 is rectangular in sectional shape. In other words, when air is caused to flow by the cooling fan 51 at a fixed output, the flow rate of air flowing substantially between the thermal radiation fins 133 is little lowered. Therefore, it is possible to radiate heat from the thermal radiation fins 133 through air while keeping constant the flow rates of air flowing substantially between the thermal radiation fins, in the condition where the electric power for driving the cooling fan 51 is constant, and it is possible to achieve stable power generation while keeping constant the temperature of the power generation unit 130. In addition, the curvature R of the curved surfaces 176 and the curvature r of the curved surfaces 175 may be set to required values according to the difference in the position of the thermal radiation fin 133 in the lamination direction, and the resistance against the flow of air in the lamination direction can be set. Since the resistance against the flow of air differs along the lamination direction, it is possible to control the quantities of heat radiated from the thermal radiation fins 133, to reduce the temperature gradients in the power generation unit 130, and to make substantially uniform the temperature of the power generation unit 130 as a whole. Besides, the flow rates of air flowing between the adjacent thermal radiation fins 133 can be maintained, by controlling the surface roughness of the surfaces of the thermal radiation fins 133 and reducing the resistance against the air flowing along the surfaces of the thermal radiation fins 133.

FIGS. 17A and 17B are plan views showing the structure of the separator 131. Both surfaces of the separator main body portion 131a are provided respectively with the groove portions 138 and 143, and, when the power generation unit 130 is assembled, the groove portion 143 makes contact with a fuel electrode of the joint body 132, whereas the groove portions 138 make contact with an air electrode of the joint body 132. In addition, the separator main body portion 131a is provided with a supply hole 142 and a discharge hole 141 both connected to the groove portion 143, a connection portion 145 for connecting the groove portion 143 and the supply hole 142 to each other, and a connection portion 146 for connecting the groove portion 143 and the discharge hole 141 to each other. Besides, the thermal radiation fin 133 is provided at a side edge portion of the separator main body portion 131 a provided with the groove portions 138 and 143.

As shown in FIG. 17A, the groove portion 143 is an in-plane conduit for supplying the joint body 132 with hydrogen gas as a fuel gas. The groove portion 143 is formed to meander in the surface of the separator main body portion 131a for the purpose of enhancing the efficiency of the power generation reaction, and is so shaped that the hydrogen gas is supplied to the whole part of the fuel electrode of the joint body 132. The supply hole 142 serves as a hydrogen gas conduit at the time of supplying the groove portion 143 with the hydrogen gas from a hydrogen gas storage portion such as a hydrogen occlusion cartridge 60 provided in the exterior of the power generation unit 130. The connection portion 145 connects the groove portion 143 and the supply hole 142 to each other, for supplying hydrogen gas into the groove portion 143. In addition, the connection portion 146 connects the groove portion 143 and the discharge hole 141 to each other, for discharging the hydrogen gas after power generation reaction from the groove portion 143. In the separator 131 according to this embodiment, the sectional areas of the connection portions 145 and 146 are set smaller than the sectional area of the groove portion upon formation of the stack structure by use of the separators 131 and the joint bodies 132; for example, the widths of the connection portions 145 and 146 are set smaller than the width of the groove portion 143. Further, the width of the connection portion 145 is set smaller than the width of the connection portion 146, whereby the width on the inlet side with respect to the hydrogen gas supplied into the groove portion 143 is set smaller than the width on the outlet side with respect to the hydrogen gas discharged from the groove portion 143.

The supply holes 142 and the discharge holes 141 are connected between the separators 131 laminated at the time of formation of the stack structure, to form a supply passage for supplying the hydrogen gas to the separators 131 and a discharge passage for discharging the hydrogen gas after power generation. When water is accumulated in the groove portion 143, the discharge passage is opened to the atmosphere by a hydrogen purge valve 54 to generate a pressure difference between the supply passage side and the discharge passage side, for the water accumulated in the groove portion 143, whereby the water can be discharged under the pressure difference. Further, even when water is accumulated in the groove portion 143 of an arbitrary separator 131 upon formation of the stack structure, a pressure difference can instantaneously be generated only in the groove portion 143 with the water accumulated therein, whereby the water can be discharged and the power generation unit 130 can be stably supplied with the hydrogen gas.

As shown in FIG. 17B, the groove portions 138 are formed on the back side of the surface provided with the groove portion 143 of the separator main body portion 131a, to serve as conduits for the flow of oxygen-containing air. The groove portions 138 are formed to extend in the width direction of the separator 131, and open to side surfaces of the separator main body portion 131a. Further, the groove portions 138 are formed in plurality along the longitudinal direction of the separator main body portion 131a. In addition, oxygen-containing air is supplied into and discharged from the groove portions 138 through the opening portions 134 and 140 opening respectively in the side surfaces of the separator main body portion 131a. The width of the opening portions 134 and 140 is set somewhat greater than the width of the groove portions 138, and the opening portions 134 and 140 can be so shaped that the side walls of the opening portions 134 and 140 have a tapered shape inclined against the side walls of the groove portions 138. According to such opening portions 134 and 140, the passage resistance against air at the time of taking air into the groove portions 138 or discharging air from the groove portions 138 can be reduced, and smooth flow of air in the groove portions 138 can be achieved. Besides, the passage resistance can further be reduced by forming the opening portions 134 and 140 so that the opening widths along the height direction of the opening portions 134 and 140 are somewhat greater than the height of the groove portions 138.

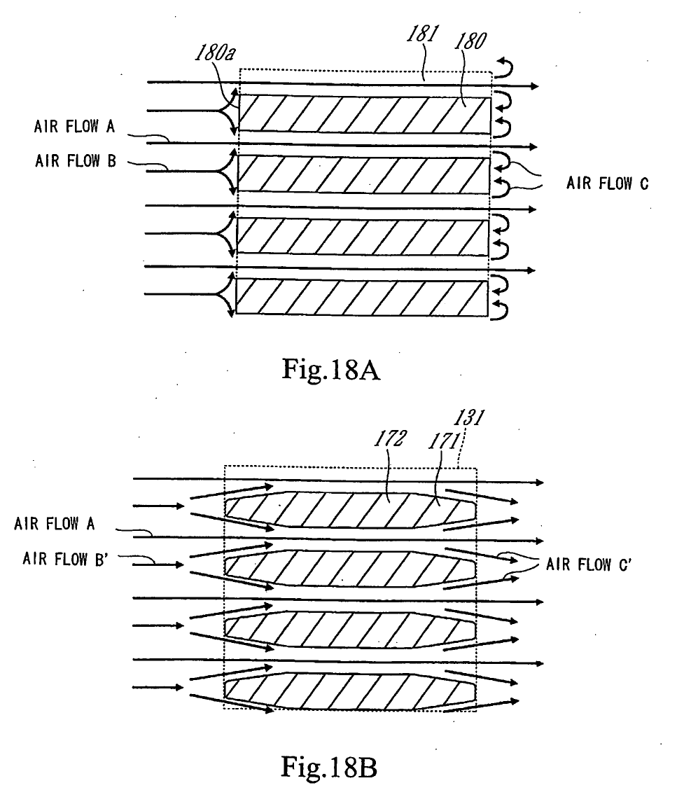

Next, referring to FIGS. 18A and 18B, the flow condition of air flowing between the thermal radiation fins will be described. FIGS. 18A and 18B illustrate the flow condition of air in the circumference of the thermal radiation fins. FIG. 18A illustrates the flow condition of air between thermal radiation fins 180 which are substantially rectangular in sectional shape and are arranged at regular intervals, and FIG. 18B illustrates the flow condition of air between the thermal radiation fins 133 constituting the power generation unit 130.

As shown in FIG. 18A, the flows of air between the thermal radiation fins 180 provided at a side edge portion of the separator main body portion 181 can be classified into three air flows A, B and C indicated by arrows in the figure. The air flow A is an air flow which goes directly into the space between the thermal radiation fins 180, without colliding against the thermal radiation fin 180. The air flow A is an air flow contributing to most part of the quantity of heat radiated from the thermal radiation fins 180. The air flow B is an air flow whose flow direction is bent by the end face of the thermal radiation fin 180; in this case, the flow of air is bent by the end face 180a opposed to the flow of air flowing in parallel to the thermal radiation fins 180.

The air flow B is blocked by the end face 180a of the thermal radiation fin 180, the flow is bent, and then air flows into the space between the thermal radiation fins 180. The air flow B interferes with the air flow A, whereby the flow rate of air flowing along the air flow A is reduced. Particularly, as the space between the thermal radiation fins 180 is narrowed, the degree of interference between the air flows A and B increases, and the proportion by which the flow rate of air flowing along the air flow A increases. Where the flow rate of air flowing through the space between the thermal radiation fins 180 is reduced, the quantity of heat radiated from the thermal radiation fins 180 is reduced, and it becomes difficult to efficiently suppress the temperature rise in the power generation unit.

Further, on the outlet side of the air flowing between the thermal radiation fins 180, an air flow C in which air flows in a vortex form is generated. The air flow C is generated when air flows out into a space wider than the space between the thermal radiation fins 180, and, particularly, it is more liable to be generated as the width of the space between the thermal radiation fins 180 is narrower. In other words, the air flow C is more liable to be generated as the space between the thermal radiation fins is narrowed more in order to reduce the size of the fuel cell device. The air flow C inhibits the air flow A going out of the space between the thermal radiation fins 180, whereby the flow rate of the air flow A is reduced.

The quantity of heat radiated from the thermal radiation fins 180 are largely owing to the air flows A, and it is important to sufficiently secure the flow rate of the air flows A. A reduction in the flow rate of the air flows A by the air flows B and C would narrow the range of temperature control over the power generation unit. Therefore, it is important to suppress the air flows B and C, for controlling the flow rate of air and thereby controlling the temperature of the power generation unit.

As shown in FIG. 18B, according to the thermal radiation fins 133, the air flows B and C shown in FIG. 18A are little generated, and it is possible to sufficiently secure the flow rate of air due to the air flows A. As has been mentioned above, the edge portions of the thermal radiation fins 133 are substantially tapered in sectional shape, and the space between the thermal radiation fins is gradually narrowed over the range from the edge portions to the central portions of the thermal radiation fins 133. Therefore, since the space between the thermal radiation fins 133, or the air passage, is smoothly narrowed, on the inlet side with respect to air, an air flow B′ corresponding to the air flow B flows smoothly into the space between the thermal radiation fins to be combined with the air flow A. In addition, on the outlet side with respect to air, the air passage is gradually broadened over the range from the central portions 172 to the edge portions 171 of the thermal radiation fins 133, so that an air flow C′ corresponding to the air flow C rarely generates a vortex-like flow, and air smoothly flows out from the space between the thermal radiation fins to the outside.

Thus, by setting the edge portions of the thermal radiations fins tapered in sectional shape and further providing curved surfaces at the boundaries between the respective surfaces fronting on the flow of air, it is possible to reduce the pressure loss in the space between the thermal radiation fins, and to permit air to flow smoothly. Therefore, it is possible to accurately control the flow rate of air supplied into the spaces between the thermal radiation fins, and, by combining this with regulation of the quantities of heat radiated from the thermal radiation fins, it is possible to accurately control the temperature of the power generation unit. Further, even at the time of reducing the size of the power generation unit, air can be made to flow at a required flow rate while suppressing the output of the cooling fan, and power generation can be performed while suppressing the electric power required for achieving stable power generation. Accordingly, the fuel cell device can be reduced in size and suppressed in consumption of electric power at the time of performing power generation.

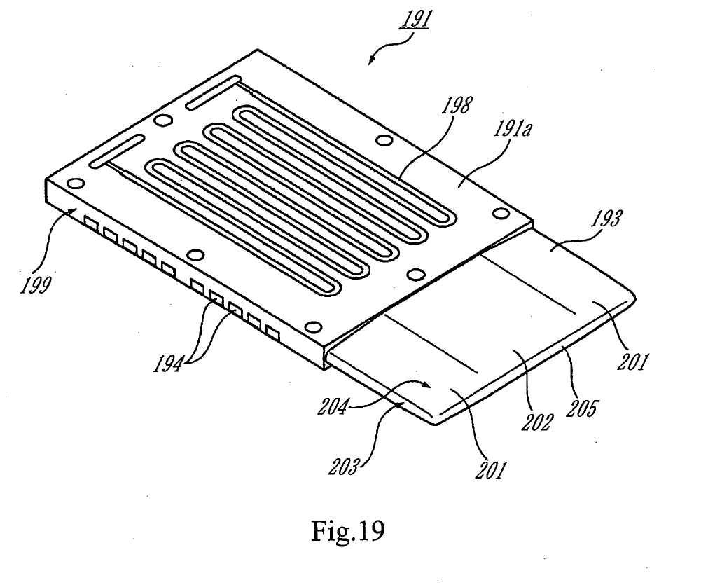

In the next place, referring to FIG. 19, another example of the separator according to the present invention will be described. FIG. 19 is a perspective view showing the structure of a separator. The separator 191 includes a separator main body portion 191a and a thermal radiation fin 193, and the separator main body portion 191a has substantially the same structure as that of the separator main body portion 131a. The separator main body portion 191a is provided on its face side with a groove portion 198 for supplying a power generation unit with hydrogen gas as a fuel, and is provided on its back side with groove portions for supplying the power generation unit with air.

Edge portions 201 of the thermal radiation fin 193 each include an end face 203 faced substantially orthogonal to the flow of air, and inclined surfaces 204 inclined against the surfaces of a central portion 202 of the thermal radiation fin 193, with the edge portions 201 being substantially tapered in sectional shape. One of the edge portions 201 fronts on the inlet side with respect to air flowing between the thermal radiation fins 193 disposed adjacent to each other at the time of forming the power generation unit having a stack structure, and the other of the edge portions fronts on the outlet side with respect the air. The inclined surfaces 204 of the edge portions 201 each extend from a side edge portion of the separator main body portion 191a to a tip end portion of the thermal radiation fin 193, and are each formed over the entire part of the edge portion 201 of the thermal radiation fin 193. In addition, the tip end portion 205 of the thermal radiation fin 193 which extends substantially in parallel to the side edge portion of the separator main body portion 191a is also substantially tapered in sectional shape, in the same manner as the sectional shapes of the edge portions 201. According to the separator 191 in this example, the resistance against the flow of air in the space between the thermal radiation fins 193 can further be reduced, as compared with the case where the edge portions 201 are substantially tapered in sectional shape, and it is possible for air to smoothly flow in the vicinity of the edge portion constituting the tip end portion 205 of the thermal radiation fin 193. It is possible to reduce the resistance to the flow. Therefore, in the case where the power generation unit as a fuel cell main body is formed by laminating the separators 191 and power generation bodies, it is possible to reduce the resistance at the time when air flows over the entire part of the thermal radiation fins 193 disposed at regular intervals in the lamination direction, and the flow rate of air receiving heat from the thermal radiation fins 193 can always be secured sufficiently. In other words, since it is possible to permit air to flow at constant flow rates, the quantities of heat radiated from the thermal radiation fins 193 can be controlled according to the flow rates of air, and it is possible to accurately control the temperature of the power generation unit.

In addition, according to the temperature control method for a fuel cell device of the present invention, it is possible to assemble a power generation unit having a stack structure by use of the above-mentioned thermal radiation fins 133 or the separators having the thermal radiation fins 193, to permit air to flow in the circumference of the thermal radiation fins, and to release heat to air which is smoothly replaced in the spaces between the thermal radiation fins, and the quantities of heat radiated can be controlled by regulating the flow rates of air by a cooling fan. Therefore, it is possible to accurately control the temperature of the power generation unit. Further, it is possible to keep constant the flow rate of air without enhancing the output of the cooling fan, leading to a reduction in loss of driving power in the case where the cooling fan and various apparatuses mounted in or on the fuel cell device are driven by the electric power supplied from the power generation unit.

### INDUSTRIAL APPLICABILITY

As has been described above, according to the separator and the fuel cell device of the present invention, even in the case where a power generation unit as a fuel cell main body has a stack structure, a temperature gradient would not be generated in the power generation unit with respect to the lamination direction of separators and joint bodies, and stable power generation can be achieved while maintaining the power generation unit as a whole at a substantially uniform temperature.

Further, according to the separator and the fuel cell device of the present invention, it is possible to provide a fuel cell device such that the quantities of heat radiated by thermal radiation fins can be controlled without changing the outer sizes of the separators and that temperature can be kept substantially uniform at the time of power generation, without changing the size or design of the power generation unit. According to such a separator and a fuel cell device, a small-type fuel cell device can be mounted on any of various electronic apparatuses driven by driving power received from the fuel cell device.

In addition, according to the temperature control method for a fuel cell device of the present invention, by permitting air to flow in the circumference of thermal radiation fins and regulating the quantities of heat radiated to the flowing air according to the difference in the position of each thermal radiation fin, the temperature gradient in a power generation unit having a stack structure with respect to the lamination direction can be suppressed, and stable power generation can be achieved while keeping uniform the temperature of the power generation unit as a whole.

Further, it is possible to reduce the resistance against the flow of air, and to permit air to flow smoothly between the thermal radiation fins provided in a fuel cell main body having a stack structure. Therefore, it is possible to accurately control the flow rates of air flowing between the thermal radiation fins, and to accurately control the quantities of heat radiated from the thermal radiation fins according to the flow rates of air. This makes it possible to cool a power generation unit serving as the fuel cell main body, thereby achieving a temperature control.

Furthermore, according to the separator and the fuel cell device of the present invention, in the case where driving power for driving various apparatuses mounted in or on the fuel cell device is supplied from a power generation unit, it is possible to reduce the consumption of electric power by these apparatuses, and to enhance the power generation efficiency of the fuel cell device as a whole.

In addition, according to the separator and the fuel cell device of the present invention, the flow rates of air can be accurately controlled by a cooling fan or the like, so that the temperature of a power generation unit can be controlled according to the flow rates of air, and to widen the temperature control range according to the flow rates.

Furthermore, according to the separator and the fuel cell device of the present invention, even in the case where the spaces between thermal radiation fins are narrowed in reducing the size of the fuel cell device, air can be permitted to flow at sufficient flow rates between the thermal radiation fins. Therefore, it is possible to increase the quantities of heat radiated from the thermal radiation fins, and to reduce the size of the thermal radiation fins according to the increases in the quantities of heat radiated, leading a further reduction in the size of the fuel cell device.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-36. (canceled)

37. A separator laminated so as to make electrical conduction between a power generation body and another power generation body, comprising:
a separator main body portion making contact with said power generation body; and
a thermal radiation portion projectingly provided at a side edge portion of said separator main body portion; wherein
a sectional area of said thermal radiation portion varies with respect to a difference in a position at which said separator main body portion is disposed with respect to a lamination direction of said power generation body and said separator main body portion.

38. The separator as set forth in claim 37, wherein
the sectional area of said thermal radiation portion is greater than a thermal radiation portion disposed on an outside relative to a first-mentioned thermal radiation portion with respect to said lamination direction, in a fuel cell main body comprising a lamination of said power generation bodies and said separator main body portion.

39. The separator as set forth in claim 37, wherein
said thermal radiation portion is substantially flat.

40. The separator as set forth in claim 37, wherein
the sectional area of said thermal radiation portion is set by varying at least one of a width and a thickness of said thermal radiation portion.

41. A separator laminated so as to make electrical conduction between a power generation body and another power generation body, comprising:
a separator main body portion making contact with said power generation body; and
a thermal radiation portion projectingly provided at a side edge portion of said separator main body portion; wherein
a surface area of said thermal radiation portion varies with respect to a difference in a position at which said separator main body portion is disposed with respect to a lamination direction of said power generation body and said separator main body portion.

42. The separator as set forth in claim 41, wherein
the surface area of said thermal radiation portion is greater than a surface area of a thermal radiation portion disposed on an outside relative to a first-mentioned thermal radiation portion with respect to said lamination direction, in a fuel cell main body comprising a lamination of said power generation body and said separator main body portion.

43. The separator as set forth in claim 41, wherein
said thermal radiation portion is substantially flat.

44. The separator as set forth in claim 41, wherein
the surface area of said thermal radiation portion is set by varying at least one of a width, a length, and a thickness of said heat generation portion.

45. A separator laminated so as to make electrical conduction between a power generation body and another power generation body, comprising:
a separator main body portion making contact with said power generation body; and
a thermal radiation portion projectingly provided at a side edge portion of said separator main body portion; wherein
the thermal emissivity of said thermal radiation portion varies with respect to a difference in a position at which said separator main body portion is disposed with respect to a lamination direction of said power generation body and said separator main body portion.

46. The separator as set forth in claim 45, wherein
the thermal emissivity of said thermal radiation portion is greater than a thermal emissivity of a thermal radiation portion disposed on an outer side relative to a first-mentioned thermal radiation portion with respect to said lamination direction, in a fuel cell main body having said power generation bodies and said separator main body portions laminated on each other.

47. The separator as set forth in claim 45, wherein
the thermal emissivity of said thermal radiation portion is set by varying a surface roughness of a surface of said thermal radiation portion.

48. The separator as set forth in claim 45, wherein
the thermal emmisivity of said thermal radiation portion is set by changing a surface treatment applied to a surface of said thermal radiation portion.

49. A fuel cell device comprising a fuel cell main body having a separator laminated so as to make electrical conduction between a power generation body and another power generation body, wherein
said separator comprises a separator main body portion making contact with said power generation body, and a thermal radiation portion projectingly provided at a side edge portion of said separator main body portion; and
an interval between said thermal radiation portions adjacent to each other with respect to a lamination direction of said power generation units and said separator main body portions is set to a required interval according to a difference in a position at which said thermal radiation portion is disposed in said fuel cell main body with respect to said lamination direction.

50. The fuel cell device as set forth in claim 49, wherein
thermal radiation from said thermal radiation portions is effected by causing an oxidizing fluid supplied to said fuel cell main body to flow between said thermal radiation portions.

51. The fuel cell device as set forth in claim 49, wherein
said required interval is smaller as said adjacent thermal radiation portions are located on an outer side of said fuel cell main body with respect to said lamination direction.

52. The fuel cell device as set forth in claim 49, wherein
a thickness of said separator main body portion is smaller as said separator main body portion is located on an outer side of said fuel cell main body with respect to said lamination direction.

53. The fuel cell device as set forth in claim 49, wherein
a difference between a thickness of said thermal radiation portion and a thickness of said separator main body portion on which said thermal radiation portion is projectingly provided is smaller on an outer side of said fuel cell main body with respect to said lamination direction.

54. A fuel cell device comprising a fuel cell main body having a separator laminated so as to make electrical conduction between a first power generation body and a second power generation body adjacent to said first power generation body, wherein
said separator comprises a separator main body portion making contact with said first and second power generation bodies, and a thermal radiation portion projectingly provided at a side edge portion of said separator main body; and
a sectional area of said thermal radiation portion varies with respect to a difference in a position at which said separator main body portion is disposed with respect to a lamination direction of said power generation bodies and said separator main body portion.

55. A fuel cell device comprising a fuel cell main body having a separator laminated so as to make electrical conduction between a first power generation body and a second power generation body, wherein
said separator comprises a separator main body portion making contact with said power generation bodies, and a thermal radiation portion projectingly provided at a side edge portion of said separator main body portion; and
a surface area of said thermal radiation portion varies with respect to difference in a position at which said separator main body portion is disposed with respect to a lamination direction of said power generation bodies and said separator main body portion.

56. A fuel cell device comprising a fuel cell main body having a separator laminated so as to make electrical conduction between a first power generation body and a second power generation body, wherein
said separator comprises a separator main body portion making contact with said power generation bodies, and a thermal radiation portion projectingly provided at a side edge portion of said separator main body portion; and
a thermal emmissivity of said thermal radiation portion varies with respect to a difference in a position at which said separator main body portion is disposed with respect to the lamination direction of said power generation bodies and said separator main body portion.

57. A temperature control method for a fuel cell device, comprising controlling temperature of a fuel cell main body in which a power generation body and a separator for making electrical conduction between said power generation body and another power generation body are laminated, wherein
said separator comprises a separator main body portion making contact with said power generation bodies, and a thermal radiation portion projectingly provided at a side edge portion of said separator main body portion;
a cooling fluid for cooling said fuel cell main body is made to flow in the circumference of said thermal radiation portion; and
a quantity of heat radiated from said thermal radiation portion is controlled according to a difference in a position at which said thermal radiation portion is disposed with respect to a lamination direction of said thermal radiation portions and said separator.

58. A separator laminated so as to make electrical conduction between a power generation body and another power generation body, comprising:
a separator main body portion making contact with said power generation bodies; and
a thermal radiation portion projectingly provided at a side edge portion of said separator main body portion; wherein
a thickness of at least a part of an edge portion of said thermal radiation portion is smaller than a thickness of a central portion of said thermal radiation portion.

59. The separator as set forth in claim 58, wherein
a cooling fluid for cooling said thermal radiation portion is made to flow in a circumference of said thermal radiation portion.

60. The separator as set forth in claim 59, wherein
said edge portion of said thermal radiation portion fronts on a side of an inlet through which said cooling fluid flows into an area between said thermal radiation portions located adjacent to each other in a lamination direction of said power generation bodies and said separator main body portion.

61. The separator as set forth in claim 59, wherein
said edge portion of said thermal radiation portion fronts on a side of an outlet through which said cooling fluid flows out of an area between said thermal radiation portions located adjacent to each other in a lamination direction of said power generation bodies and said separator main body portion.

62. The separator as set forth in claim 58, wherein
said edge portion of said thermal radiation portion extends along a direction in which said thermal radiation portion is projectingly provided and extends from said side edge portion of said separator main body portion.

63. The separator as set forth in claim 58, wherein
a section of said edge portion is tapered in shape.

64. The separator as set forth in claim 63, wherein
a section of said central portion is rectangular, and said edge portion comprises an inclined surface inclined against a surface of said central portion.

65. The separator as set forth in claim 64, wherein
a boundary between a surface of said central portion and said inclined surface is a curved surface.

66. The separator as set forth in claim 64, wherein
a boundary between said inclined surface and an end face of said edge portion is a curved surface.

67. The separator as set forth in claim 64, wherein
a curvature of a curved surface as a boundary between a surface of said central portion and said inclined surface is greater than a curvature of a curved surface as a boundary between said inclined surface and an end face of said edge portion.

68. The separator as set forth in claim 64, wherein
a curvature of a curved surface as a boundary between a surface of said central portion and said inclined surface and a curvature of a curved surface as a boundary between said inclined surface and an end face of said edge portion are set to required values according to a difference in a position at which said thermal radiation portion is disposed in a lamination direction of said power generation bodies and said separator main body portion.

69. The separator as set forth in claim 58, wherein
said edge portion of said thermal radiation portion is a tip end portion of said thermal radiation portion which is so provided as to extend from said side edge portion of said separator main body portion.

70. The separator as set forth in claim 58, wherein
a surface of said thermal radiation portion has a required surface roughness so as to reduce a resistance which would inhibit the flow of a cooling fluid for cooling said thermal radiation portion.

71. A fuel cell device comprising a fuel cell main body in which a power generation body and a separator for making electrical conduction between said power generation body and another power generation body are laminated, wherein
said separator comprises a separator main body making contact with said power generation bodies, and a thermal radiation portion projectingly provided at a side edge portion of said separator main body portion; and
a thickness of at least a part of an edge portion of said thermal radiation portion is set smaller than a thickness of a central portion of said thermal radiation portion.

72. A temperature control method for a fuel cell device, comprising controlling temperature of a fuel cell main body in which a power generation body and a separator for making electrical conduction between said power generation body and another power generation body are laminated, wherein
said separator comprises a separator main body portion making contact with said power generation bodies, and a thermal radiation portion projectingly provided at a side edge portion of said separator main body portion;
a thickness of at least a part of an edge portion of said thermal radiation portion is set smaller than a thickness of a central portion of said thermal radiation portion; and
a cooling fluid for cooling said fuel cell main body is made to flow in a circumference of said thermal radiation portion.
